(19) United States
(12) Patent Application Publication
(10) Pub. No.: US 2026/0329846 A1
(43) Pub. Date: Oct. 22, 2026

(54) SYSTEM

(71) Applicant: SoftBank Group Corp., Tokyo (JP)

(72) Inventor: Akira KAMIYAMA, Tokyo (JP)

(73) Assignee: SoftBank Group Corp., Tokyo (JP)

(21) Appl. No.: 19/650,368

(22) Filed: Apr. 17, 2026

(30) Foreign Application Priority Data
Apr. 22, 2025 (JP) 2025-070194

(51) Int. Cl. G06F 16/23; G06N 5/04

(52) U.S. Cl. CPC G06F 16/2365; G06N 5/04

(57) ABSTRACT

The present invention relates to an AI governance support system that collects operation logs of an AI system in real time, automatically performs transparency evaluation, bias detection, and determination of compliance with laws, regulations, and ethical guidelines using generative AI, autonomously generates a specific corrective measure using the generative AI when a violation or bias is detected, and immediately presents the corrective measure to related parties through a dashboard or the like. Thereby, in large-scale organizations, government agencies, and the like under strict legal regulations such as finance, medical care, and communications, it becomes possible to solve problems of a black box nature, fairness, and legal compliance of the AI system in real time and autonomously, and to dramatically improve reliability and accountability in social implementation of AI technology.

### CROSS-REFERENCE TO RELATED APPLICATION

The present application claims priority to and incorporates by reference the entire contents of Japanese Patent Application No. 2025-070194 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, in large-scale organizations such as industries with strict legal regulations including finance, medical care, and communications, government agencies, and large non-profit organizations, there are problems of a black box nature occurring with the operation of an AI system, that is, a problem that a decision-making process of the AI is opaque and a basis of an output is difficult to understand, a bias risk caused by a bias in training data or a flaw in algorithm design, that is, a risk that an unfair decision is made for a specific attribute or group, and a problem that it is difficult to secure compliance with laws, regulations, and ethical guidelines that are frequently updated in each country and each industry, and for these problems, conventionally, since it has relied on inefficient and person-dependent means such as manual log monitoring, periodic reviews, and manual responses by specialized engineers and legal departments, it has been difficult to secure transparency, fairness, and legal compliance of the AI system in real time and autonomously, and to enhance reliability and accountability in social implementation of AI technology.

### SUMMARY OF THE INVENTION

Means for solving the problem according to the present invention is to configure a system for supporting governance of an AI system, the system comprising: an operation monitoring unit configured to collect operation logs of the AI system in real time; a compliance evaluation unit configured to analyze the operation logs collected by the operation monitoring unit using generative AI, evaluate transparency of a decision-making process of the AI system, determine presence or absence of bias based on input data and output results using a statistical method and a machine learning method, automatically acquire contents of latest laws, regulations, and ethical guidelines from an external database or an API, analyze the contents by natural language processing, and determine whether an operation of the AI system complies with the regulations and the guidelines; and a correction proposal unit configured to, based on results of the bias detection and the compliance evaluation, autonomously generate a specific correction proposal using the generative AI when correction is necessary, and immediately present the correction proposal to management and engineers as a dashboard or a report, wherein the respective units cooperate to realize elimination of a black box nature of the AI system, securing of fairness, and maintenance of legal compliance in real time and autonomously.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

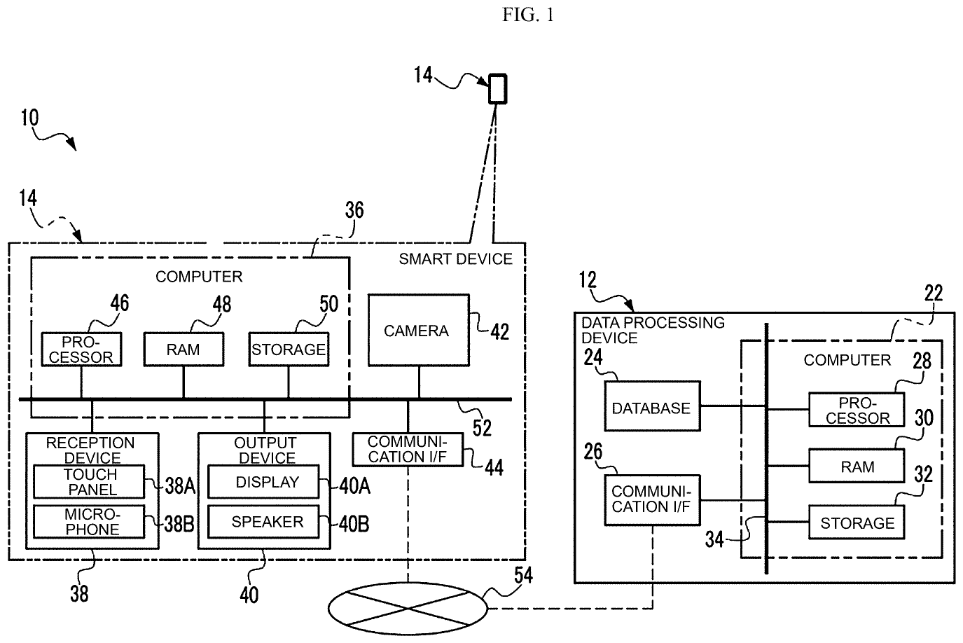

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

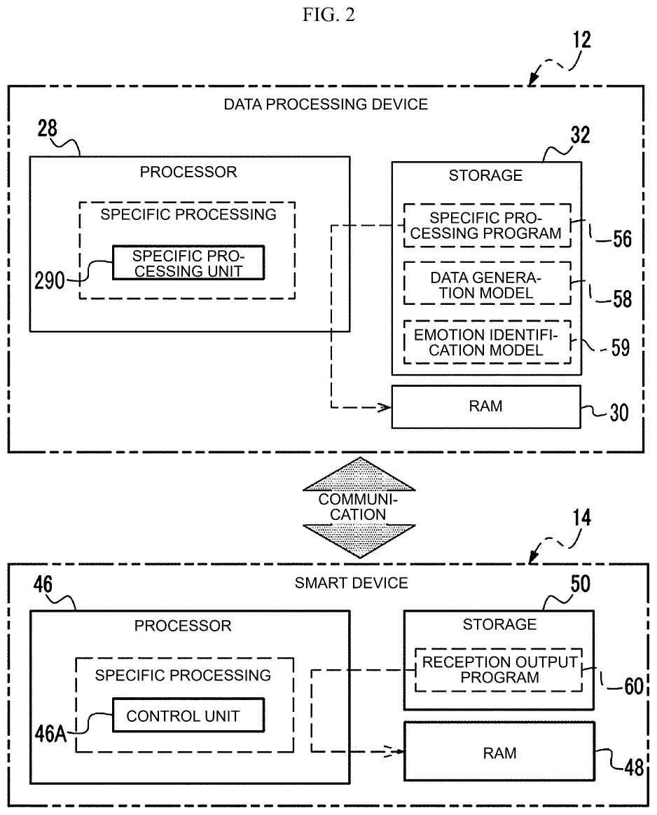

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail.

The system of the present invention is composed of a server and a terminal, and is configured such that main processing functions are concentrated on the server side, and the terminal side is provided with a user interface and some data acquisition and display functions. For example, the server is installed in a cloud environment or a data center, and the terminal is composed of various devices such as a PC, a tablet, a smartphone, and a dedicated terminal. The server and the terminal perform bidirectional communication via a secure network using an API, WebSocket, or the like. Specifically, the present system arranges a parallel computing cluster using GPUs on the server side. The present system implements a large-capacity memory and a high-speed storage on the server side. The present system implements a lightweight rendering engine on the terminal side. The present system establishes a secure communication path using TLS encryption between the server and the terminal. The present system adopts gRPC or RESTful API as a communication protocol. The present system compresses a communication payload using a data serialization method. The present system transmits sensor data and user inputs acquired on the terminal side to the server in real time. The present system executes inference processing of a heavy machine learning model on the server side. The present system returns only an inference result to the terminal. The present system significantly offloads a calculation load on the terminal side. The present system suppresses battery consumption of the terminal. The present system realizes a low-latency response in streaming data processing from an edge device. The present system improves processing efficiency of the entire system by optimal allocation of hardware resources.

First, the operation monitoring unit collects all operation logs generated by the AI system in the server in real time. For example, in the case of a credit examination AI in the financial industry, extremely diverse and detailed information such as an age, a gender, an occupation, a residential area, an application amount, a past transaction history, a credit score of an examination target person, an examination time, an examiner ID, a version of an AI model, a value of a feature amount used for inference, an output result (approval/rejection) of the AI, an output certainty score, and an ID of a past case referred to by the AI is recorded case by case and transmitted to the server. In the case of a diagnosis support AI in the medical field, a patient's age, gender, chief complaint, medical history, examination data (blood test value, diagnostic imaging result, etc.), a diagnosis result, a diagnosis basis, a version of an AI model, a diagnosis time, a diagnosing doctor ID, an ID of a paper or a guideline referred to by the AI, and the like are recorded. In the case of an AI chatbot in the telecommunications industry, a user's attribute (age, gender, contract plan, used terminal), an inquiry content, a response content of the AI, a prompt at the time of response generation, a version of an AI model, a response generation time, a past similar inquiry ID, and the like are recorded. These logs are acquired on the terminal side, then transmitted to the server side by encrypted communication, and accumulated in a database on the server side in chronological order. Specifically, the operation monitoring unit converts raw data transmitted from each terminal into structured data. The operation monitoring unit executes preprocessing such as missing value completion and normalization. The operation monitoring unit tokenizes text data. The operation monitoring unit formats the preprocessed data as a multidimensional vector or a time-series array. The operation monitoring unit generates a numerical vector having 256 dimensions as input data in the credit examination in the financial industry. The numerical vector includes continuous values such as an age and a credit score. The operation monitoring unit generates an image tensor having a length of 224 pixels, a width of 224 pixels, and a depth of 3 channels as input data in the medical field. The operation monitoring unit generates a text embedding vector having 768 dimensions as input data in the telecommunications industry. The operation monitoring unit inputs these input data to a small-scale neural network for anomaly detection. The neural network outputs a score indicating a degree of anomaly of each log. The score takes a continuous value in a range of 0.0 to 1.0. The neural network outputs a parsing result of the log in a structured format. The operation monitoring unit assigns a flag to a log whose anomaly degree score exceeds a predetermined threshold. The operation monitoring unit stores the processed log data in a time-series database with an index. The operation monitoring unit realizes unified management of data. The operation monitoring unit dramatically improves a subsequent search speed. The operation monitoring unit optimizes calculation efficiency of subsequent AI analysis.

Next, the compliance evaluation unit on the server side analyzes the collected operation logs from multiple angles using generative AI. The generative AI includes a large language model, a generative image model, a generative tabular model, and the like, and is utilized as an essential element. First, with the operation log as an input, the generative AI automatically generates a basis explanation text for each decision. For example, it generates a detailed explanation such as “This credit examination was approved on the basis that the age is 35, the credit score is 750, there is no delinquency history in the past three years, and the application amount is 1 million yen or less.” In the medical field, it generates an explanation such as “In this diagnosis, since the patient is a 60-year-old male, a nodular shadow was observed in a lung field in a chest X-ray image, and a tumor marker value exceeded a reference value, it was diagnosed as suspected lung cancer.” In the telecommunications industry, it generates an explanation such as “In this FAQ response, since the user is a female in her 20s and inquired about a communication failure of a smartphone, failure information of a corresponding area was referred to, and a scheduled restoration time was guided.” Specifically, the compliance evaluation unit includes a transformer-based large language model. The compliance evaluation unit converts the structured data of the operation log into a natural language prompt text. The compliance evaluation unit divides the prompt text into a token sequence. The compliance evaluation unit converts the token sequence into a context vector having 1024 dimensions. The compliance evaluation unit inputs the context vector to the large language model. An example of an input to the large language model is an attribute data character string of a credit examination. An example of an input to the large language model is a finding text of a medical image. An example of an input to the large language model is a dialogue history text of a chatbot. The large language model calculates a dependency relationship between input tokens using a self-attention mechanism. The large language model outputs a natural language text sequence indicating a decision basis. The large language model outputs a certainty score for each generated word. The large language model outputs an attention weight distribution indicating which part of the input data is focused on. The compliance evaluation unit executes syntax analysis on the output text sequence. The compliance evaluation unit extracts an important keyword from the text. The compliance evaluation unit transmits the extracted keyword and the certainty score to a display module of a dashboard. The compliance evaluation unit visualizes an internal state of the black-boxed AI. The compliance evaluation unit technically improves transparency and accountability of the system.

Furthermore, the generative AI analyzes a large amount of past operation logs using a statistical method and a machine learning method, and automatically detects an output tendency for each attribute and presence or absence of bias. For example, it analyzes the output tendency of the AI from various perspectives such as by age, by gender, by region, by occupation, by disease, and by contract plan, and extracts a bias tendency such as “a rejection rate of female applicants is 10% higher than that of male applicants”, “there is a specific bias in diagnosis results of elderly people”, and “a satisfaction level of FAQ responses is low for users in a specific region”. The generative AI explains in detail in a natural language not only a mere numerical bias but also “why the bias occurs”, “what kind of impact there is”, “between which attributes there is a significant difference”, and the like. For example, it explains even a causal relationship such as “The reason why the rejection rate of female applicants is high is that a ratio of female samples in training data is low and there is a bias in past credit histories.” Specifically, the generative AI expands the past operation logs as a multidimensional tensor on a memory. The multidimensional tensor has, for example, 10,000 samples and 128 feature amounts. The generative AI maps high-dimensional data to a low-dimensional space using principal component analysis. The generative AI groups similar logs using a clustering algorithm. The generative AI calculates a fairness index for each group. The generative AI receives the multidimensional tensor as an input. The generative AI receives a numerical vector indicating a statistical difference for each attribute as an input. The generative AI outputs a bias score. The bias score is a continuous value from 0.0 to 1.0. The generative AI outputs a contribution degree vector indicating a degree of influence of each feature amount on the bias. The generative AI outputs a natural language text explaining a cause of the bias. The generative AI transmits the output bias score to a monitoring module. The monitoring module triggers an alert when the bias score is 0.7 or more. The monitoring module transmits an alert signal to the correction proposal unit as a trigger. The generative AI automatically discovers a hidden bias in a high-dimensional space that is difficult for a human to notice. The generative AI ensures fairness of a machine learning model based on a mathematical basis.

In addition, the compliance evaluation unit automatically acquires latest regulation information from an external legal regulation database or an industry guideline API periodically or in real time, and analyzes its content by natural language processing using the generative AI. For example, when a regulation such as “prohibition of credit to persons under 18 years old”, “restriction on lending to a specific occupation”, or “prohibition of service provision to antisocial forces” is newly added or revised in the financial industry, the generative AI reads the regulation document, compares it with the operation log of the AI system, and determines presence or absence of a violation. In the medical field, it automatically analyzes a guideline such as “confirmation by a doctor is always required when outputting a specific diagnosis result” or “there is an age/weight restriction for prescription of a specific drug”, and checks whether the output of the AI system violates this. In the telecommunications industry, it automatically acquires a regulation such as “prohibition of specific service guidance to minors” or “restriction on service provision in a specific region”, and determines whether the response content of the AI chatbot conflicts with these. Since the generative AI determines the wording of laws, regulations, and guidelines not by a mere keyword search but after understanding a context and an intention, it can flexibly respond to a complex regulation and an ambiguous expression. Specifically, the compliance evaluation unit converts a legal regulation text acquired from an external API into a word embedding vector. The word embedding vector has 1024 dimensions. The compliance evaluation unit generates a context vector using a transformer encoder. The compliance evaluation unit calculates a cosine similarity between a vector generated from the operation log and the context vector of the legal regulation. The compliance evaluation unit receives the word embedding vector as an input. The compliance evaluation unit receives a vector representation of the operation log as an input. The compliance evaluation unit outputs a violation probability score. The violation probability score takes a range of 0.0 to 1.0. The compliance evaluation unit outputs an article identifier of the corresponding legal regulation. The compliance evaluation unit outputs coordinate data for highlighting indicating a violation part. The compliance evaluation unit issues a system stop command when the violation probability score exceeds a predetermined threshold. The compliance evaluation unit transmits the system stop command to a control module. The compliance evaluation unit transmits violation detail data to an alert generation module. The compliance evaluation unit enables immediate tracking of the system to a change in legal regulations. The compliance evaluation unit autonomously reduces a compliance violation risk. The compliance evaluation unit completely eliminates a manual visual confirmation work.

The correction proposal unit autonomously generates a specific corrective measure using the generative AI when bias or a compliance violation is detected. For example, when bias is detected, it generates various proposals such as “increasing the number of female samples in training data”, “introducing an attribute bias reduction algorithm”, “redesigning a part of a decision-making logic”, “executing re-learning of an AI model”, “adding a bias detection filter”, and “introducing a double check by a human for an output of the AI”. In the case of a legal regulation violation, it presents a specific operational improvement measure such as “enhancing an age check function of input data”, “automatically excluding users in a specific region”, “temporarily suspending automatic notification of a diagnosis result and making confirmation by a doctor mandatory”, “adding an attribute filter of a service provision target person”, and “automatically inserting a regulation wording into a response content of the AI”. These proposals are autonomously documented by the generative AI based on past cases, latest technology trends, regulation contents, industry standards, internal policies, and the like, and are immediately reflected on a dashboard on the terminal side. Specifically, the correction proposal unit constructs an optimal corrective measure using a retrieval-augmented generation technology. The correction proposal unit receives the bias score as an input. The correction proposal unit receives a vector representation of a violation content as an input. The correction proposal unit receives a search result text from a past success case database as an input. The correction proposal unit evaluates a plurality of corrective measure candidates using a reinforcement learning algorithm. The correction proposal unit outputs a text sequence of the corrective measure. The correction proposal unit outputs an expected effect score of each corrective measure. The correction proposal unit outputs an implementation difficulty score of each corrective measure. The correction proposal unit executes ranking of proposals based on the expected effect score and the implementation difficulty score. The correction proposal unit transmits a top-ranked proposal to a dashboard display unit in a structured data format. The correction proposal unit significantly speeds up a cycle of system modification. The correction proposal unit minimizes downtime by automatic selection of an optimal corrective measure. The correction proposal unit technically realizes a self-healing capability of the system.

Furthermore, on the server side, histories of these monitoring, evaluation, and proposal are managed in chronological order so that a user on the terminal side can refer to past proposal contents and response statuses. For example, when “data expansion for bias reduction” was proposed in the past and data expansion was actually performed, its history and effect (for example, “the rejection rate of female applicants was reduced by 5%”) can be visualized on the dashboard. Thereby, an AI system operator can continuously grasp an implementation status and an improvement effect of the corrective measure. Specifically, the server manages history data using a time-series database. The server prevents falsification of the history data using a distributed ledger technology. The server receives a time stamp as an input. The server receives a proposal identifier as an input. The server receives a flag indicating an implementation state as an input. The server receives a numerical vector indicating an effect measurement metric as an input. The server hashes these input data and records them in a blockchain. The server outputs array data for drawing a time-series trend graph. The server outputs text data of an effect verification report. The server transmits the output data to a periodic batch processing module. The batch processing module detects long-term deterioration of model performance. The batch processing module calculates an occurrence probability of concept drift. The server guarantees reliable storage of an audit trail. The server establishes a continuous model improvement cycle. The server improves reliability of data management by a cryptographic technology.

On the terminal side, a dashboard display unit visualizes a monitoring result, a bias detection status, a compliance evaluation result, a correction proposal content, and the like received from the server in real time. For example, it displays summary information such as “the current AI system has no bias and no legal regulation violation” for management, and displays a detailed proposal such as “review of training data is recommended because the rejection rate of female applicants is high” for engineers. An alert notification unit immediately notifies a related party by various means such as a pop-up notification, an email notification, a chat notification, and a push notification of a smartphone on the terminal side when a serious bias or legal regulation violation is detected. In a feedback input unit from a user, an operation person in charge can input a response status and an additional comment to the proposal content, and these pieces of information are also centrally managed on the server side. Specifically, the dashboard display unit establishes real-time bidirectional communication with the server using WebSocket. The dashboard display unit receives a structured payload from the server. The structured payload includes an alert level. The structured payload includes a message text. The structured payload includes coordinate data for drawing a graph. The dashboard display unit analyzes the received payload. The dashboard display unit dynamically renders a document object model element based on an analysis result. The dashboard display unit outputs a trigger signal of a push notification when receiving a serious alert. The dashboard display unit captures a user's click event. The dashboard display unit captures a user's text input. The dashboard display unit transmits the captured event data to the server by asynchronous communication. The dashboard display unit reduces a user's cognitive load. The dashboard display unit supports quick decision-making. The dashboard display unit efficiently implements a human-in-the-loop mechanism.

For example, in an AI chatbot in the telecommunications industry, when incorrect guidance is repeated to users of a specific age group or region, the operation monitoring unit collects the log, the generative AI automatically determines that “an FAQ answer is inappropriate for users in a specific region”, and generates a correction proposal such as “regional optimization of an FAQ database” or “improvement of a response logic according to a user attribute”. Furthermore, when “prohibition of specific service guidance to minors” is added due to a revision of legal regulations, the generative AI analyzes the regulation content, extracts a corresponding log, and proposes “addition of a filter that automatically blocks guidance to minors”. Specifically, the operation monitoring unit extracts a dialogue history of the chatbot as a text sequence. The operation monitoring unit encodes a user attribute as a numerical vector. The generative AI receives the text sequence as an input. The generative AI receives the user attribute vector as an input. The generative AI outputs an inappropriate response probability score. The generative AI outputs a regular expression pattern of a filtering rule. The generative AI transmits the output regular expression pattern to a routing module of the chatbot. The routing module dynamically applies the received pattern to block an inappropriate response. The present system automatically improves quality of a communication service. The present system completely automates a process of legal compliance. The present system prevents a disadvantage to a specific user group in advance.

Further, for example, in an image diagnosis support system using AI, when a misdiagnosis rate is high in a specific race or age group, the operation monitoring unit detects the tendency, and the generative AI proposes various corrective measures such as “increasing image samples of the corresponding race and age group in the training data”, “improving an image preprocessing algorithm”, and “requiring an additional review by a doctor for a diagnosis result”. Furthermore, when “a new examination item is essential for diagnosing a specific disease” due to a revision of medical guidelines, the generative AI analyzes the guidelines and proposes modification of input items and a diagnosis logic of the AI system. Specifically, the operation monitoring unit extracts an image tensor compliant with a medical digital image and communication standard. The image tensor has dimensions of 512 pixels in length, 512 pixels in width, and 1 channel in depth. The operation monitoring unit extracts metadata indicating a race and an age. The generative AI receives the image tensor as an input. The generative AI receives the metadata as an input. The generative AI outputs a heat map indicating a spatial distribution of misdiagnosis probabilities. The generative AI outputs a parameter set for data augmentation. The generative AI transmits the output parameter set to a generative adversarial network. The generative adversarial network generates a synthetic image of a lacking attribute using the parameter set. The system executes re-learning of a diagnosis model using the generated synthetic image. The system improves fairness of medical AI. The system realizes uniformization of diagnosis accuracy. The system enables rapid adaptation to guideline changes.

Furthermore, for example, in a personnel selection system using AI, when a pass rate of graduates from a specific university or people from a specific region is remarkably high, the operation monitoring unit detects the bias, and the generative AI proposes corrective measures such as “ensuring diversity of training data”, “adding an attribute bias correction item to a pass determination logic”, and “switching a part of a selection process to a review by a human”. Furthermore, when “prohibition of selection based on a specific attribute” is added due to a revision of labor laws and regulations, the generative AI analyzes the laws and regulations and proposes a review of a selection logic and input items of the AI system. Specifically, the operation monitoring unit extracts a natural language text of a resume. The operation monitoring unit vectorizes a numerical value of a skill evaluation. The generative AI receives the natural language text as an input. The generative AI receives the skill evaluation vector as an input. The generative AI outputs a bias contribution vector indicating a degree of influence that each feature amount has on a determination. The generative AI outputs a masking rule for concealing a specific attribute. The generative AI transmits the output masking rule to a preprocessing pipeline. The preprocessing pipeline automatically replaces a token indicating a university name or a region with a masking token. The system eliminates algorithmic prejudice in a recruitment process. The system mathematically ensures fairness of selection. The system avoids a legal risk of a labor legal regulation violation by technical means.

As described above, in the embodiment of the present invention, it is essential that the generative AI plays a core role in the entire system, such as operation log analysis of the AI system, bias detection, automatic analysis of laws, regulations, and guidelines, autonomous generation of corrective measures, automatic generation of explanatory texts, history management, immediate reflection on a dashboard, alert notification, and user feedback management, and by cooperation between advanced processing on the server side and a user interface on the terminal side, it becomes possible to secure transparency, fairness, and legal compliance of the AI system in real time and autonomously, and to enhance reliability and accountability in social implementation of AI technology. Specifically, the system aggregates status signals output from respective modules as an integrated vector. The generative AI receives the integrated vector as an input. The generative AI outputs a health score of the entire system. The health score takes an integer value from 0 to 100. The generative AI transmits the health score to a resource management module. The resource management module autonomously executes scale-out of compute nodes based on the health score. The system is integrated with a pipeline of continuous integration and continuous deployment. The system realizes autonomous operation of the AI system. The system improves scalability against load fluctuations. The system dramatically reduces human costs required for operation and maintenance.

### System Configuration

The system according to the present embodiment includes an operation monitoring unit, a compliance evaluation unit, a bias detection unit, a correction proposal unit, a history management unit, a dashboard display unit, an alert notification unit, and a user feedback management unit.

The operation monitoring unit has a function of collecting all operation logs generated by the AI system in real time and accumulating them in the server. For example, in a credit examination AI in the financial industry, an age, a gender, an occupation, a residential area, an application amount, a past transaction history, a credit score of an examination target person, an examination time, an examiner ID, a version of an AI model, a value of a feature amount used for inference, an output result of the AI, an output certainty score, an ID of a past case referred to by the AI, and the like are sequentially recorded and transmitted to the server. In a diagnosis support AI in the medical field, a patient's age, gender, chief complaint, medical history, examination data, diagnosis result, diagnosis basis, version of an AI model, diagnosis time, diagnosing doctor ID, ID of a paper or guideline referred to by the AI, and the like are recorded. In an AI chatbot in the telecommunications industry, a user's attribute, inquiry content, response content of the AI, prompt at the time of response generation, version of an AI model, response generation time, ID of a past similar inquiry, and the like are recorded. Furthermore, in a personnel selection system using AI, an applicant's educational background, work history, skill, entry sheet content, interview evaluation, pass/fail determination by the AI, determination reason, model version, selection time, and the like are recorded. After these data are acquired on the terminal side, they are transmitted to the server side by encrypted communication and accumulated in chronological order in a database on the server side. Specifically, the operation monitoring unit buffers a large amount of log data using a stream processing engine. The operation monitoring unit converts text data of personnel selection into an embedding vector with 512 dimensions. The operation monitoring unit generates a multimodal tensor by combining a voice feature amount and a facial expression feature amount of an interview evaluation. The operation monitoring unit receives the embedding vector as an input. The operation monitoring unit receives the multimodal tensor as an input. The operation monitoring unit outputs a parsed structured log record. The operation monitoring unit writes the output log record to a distributed file system. The operation monitoring unit caches frequently accessed data in an in-memory database. The operation monitoring unit realizes high-throughput log collection. The operation monitoring unit prevents data loss due to network delay. The operation monitoring unit supports stable operation of a large-scale system.

The compliance evaluation unit analyzes the operation logs collected from the operation monitoring unit using generative AI, and determines whether a decision-making process of the AI system complies with latest laws, regulations, and industry guidelines. For example, in the financial industry, when there are regulations such as “prohibition of credit to persons under 18 years old”, “restriction on lending to specific occupations”, and “prohibition of service provision to antisocial forces”, the generative AI automatically acquires latest regulation information from an external legal regulation database or an industry guideline API, collates it with the operation logs, and determines presence or absence of a violation. In the medical field, it automatically analyzes guidelines such as “confirmation by a doctor is always required when outputting a specific diagnosis result” and “there are age and weight restrictions for prescription of a specific drug”, and checks whether an output of the AI system violates them. In the telecommunications industry, it automatically acquires regulations such as “prohibition of specific service guidance to minors” and “restriction on service provision in specific regions”, and determines whether a response content of the AI chatbot conflicts with them. In a personnel selection system, it automatically acquires laws and regulations such as “prohibition of selection based on a specific attribute” and “compliance with the Act to Facilitate the Employment of Persons with Disabilities”, and determines whether a pass/fail determination by the AI violates them. As a specific example of a prompt sentence when using the generative AI, “Refer to the following operation logs of the AI system and the latest laws, regulations, and guidelines, determine in detail whether there is a regulation violation or a guideline deviation, and explain the basis thereof” and the like can be cited. Specifically, the compliance evaluation unit controls an output of the generative AI using a prompt engineering technique. The compliance evaluation unit obtains character string data of the operation logs. The compliance evaluation unit obtains a legal regulation text. The compliance evaluation unit obtains a system prompt including a role definition and a constraint condition. The compliance evaluation unit combines these and inputs them to the generative AI. The generative AI outputs a Boolean value indicating a determination result. The generative AI outputs a violation probability score. The generative AI outputs an extracted text serving as a basis. The compliance evaluation unit executes a rollback process of a corresponding transaction when the determination result indicates a violation. The compliance evaluation unit executes writing to an audit log. The compliance evaluation unit suppresses a hallucination phenomenon of the AI by optimizing the prompt. The compliance evaluation unit dramatically improves determination accuracy.

The bias detection unit analyzes a large amount of operation logs collected from the operation monitoring unit statistically and machine-learning-wise using generative AI, and automatically detects an output tendency for each attribute and presence or absence of bias. For example, it analyzes the output tendency of the AI from various perspectives such as by age, by gender, by region, by occupation, by disease, and by contract plan, and extracts a bias tendency such as “a rejection rate of female applicants is 10% higher than that of male applicants”, “there is a specific bias in diagnosis results of elderly people”, “a satisfaction level of FAQ responses is low for users in a specific region”, and “a pass rate of graduates from a specific university is remarkably high”. The generative AI explains in detail in a natural language not only a mere numerical bias but also “why the bias occurs”, “what kind of impact there is”, “between which attributes there is a significant difference”, and the like. For example, it explains even a causal relationship such as “the rejection rate of female applicants is high because a ratio of female samples in training data is low and there is a bias in past credit histories”. As a specific example of a prompt sentence when using the generative AI, “Analyze the following operation logs for each attribute, and if bias exists, explain its tendency and cause in detail” and the like can be cited. Specifically, the bias detection unit performs analysis by fusing a statistical test method and the generative AI. The bias detection unit generates an aggregation matrix of the operation logs. The bias detection unit calculates a p-value vector using a chi-square test or a t-test. The generative AI receives the aggregation matrix as an input. The generative AI receives the p-value vector as an input. The generative AI outputs a causal graph of a bias cause. The causal graph has a list structure of nodes and edges. The generative AI outputs an explanatory text in a natural language. The bias detection unit constructs a simulation environment using the output causal graph. The bias detection unit executes counterfactual inference in the simulation environment. The bias detection unit separates a mere correlation and a true causal relationship. The bias detection unit accurately identifies a root cause of bias.

The correction proposal unit autonomously generates a specific corrective measure using generative AI based on analysis results of the compliance evaluation unit and the bias detection unit. For example, when bias is detected, it generates various proposals such as “increasing the number of female samples in training data”, “introducing an attribute bias reduction algorithm”, “redesigning a part of a decision-making logic”, “executing re-learning of an AI model”, “adding a bias detection filter”, and “introducing a double check by a human for an output of the AI”. In the case of a legal regulation violation, it presents specific operation improvement measures such as “enhancing an age check function of input data”, “automatically excluding users in a specific region”, “temporarily suspending automatic notification of a diagnosis result and making confirmation by a doctor essential”, “adding an attribute filter of service provision targets”, and “automatically inserting a regulation wording into a response content of the AI”. Furthermore, it generates various corrective measures for each industry and application, such as “regional optimization of an FAQ database”, “improvement of a response logic according to a user attribute”, “making a doctor review essential for a diagnosis result”, and “switching a part of a selection process to a review by a human”. As a specific example of a prompt sentence when using the generative AI, “Based on the following bias detection results and compliance violation contents, generate a plurality of corrective measure proposals, and explain effects and implementation procedures of each in detail” and the like can be cited. Specifically, the correction proposal unit parameterizes the corrective measure and converts it into an automatically applicable format. The generative AI receives a causal graph of a bias cause as an input. The generative AI receives metadata of a compliance violation as an input. The generative AI outputs a program code snippet for executing the corrective measure. The generative AI outputs a search space definition of hyperparameters. The correction proposal unit transmits the output code snippet to a sandbox environment. The sandbox environment performs a test execution of the code and verifies safety. The correction proposal unit deploys the code that has passed the verification to a production environment. The correction proposal unit realizes automatic correction at a code level. The correction proposal unit dramatically reduces operation and maintenance costs. The correction proposal unit prevents mixing of human errors.

The history management unit centrally manages all data, analysis results, proposal contents, and response statuses generated by the operation monitoring unit, the compliance evaluation unit, the bias detection unit, and the correction proposal unit in chronological order. For example, when “data expansion for bias reduction” was proposed in the past and data expansion was actually performed, its history and effect (for example, “a rejection rate of female applicants was reduced by 5%”) are recorded. A response history at the time of legal regulation revision, an evaluation history at the time of AI model version upgrade, a feedback content from a user, a response history at the time of alert occurrence, and the like are also all recorded so that they can be searched, referred to, and analyzed later. For example, a history such as “laws and regulations were revised on Jun. 1, 2024, and a new input control was introduced from the next day” is recorded in detail. Specifically, the history management unit implements a model management mechanism similar to a version control system. The history management unit receives an event log from each unit as an input. The history management unit receives a hash value of a weight file of a model as an input. The history management unit outputs tree structure data of a change history. The history management unit outputs difference information between respective versions. The history management unit persists the output tree structure data in a storage. The history management unit executes a rollback process to a model state at an arbitrary point in the past when a failure occurs. The history management unit ensures complete reproducibility of a behavior of the AI model. The history management unit enables rapid recovery when a failure occurs. The history management unit enhances availability of the system.

The dashboard display unit visualizes monitoring results, bias detection statuses, compliance evaluation results, correction proposal contents, history information, and the like received from the server in real time on the terminal side. For example, it displays summary information such as “The current AI system has no bias and no legal regulation violation.” for management, and displays detailed proposals such as “Review of training data is recommended because a rejection rate of female applicants is high” for engineers. Furthermore, it visualizes past histories, implementation statuses of corrective measures, improvement effects, and the like using graphs, tables, chronological charts, and the like. For example, it displays “transition of the number of bias detections in the past six months”, “response history when a legal regulation violation occurs”, “performance change after implementation of a corrective measure”, and the like from multiple angles. Specifically, the dashboard display unit combines dynamic rendering technology and role-based access control. The dashboard display unit receives role information of a user as an input. The dashboard display unit receives a multidimensional data cube to be visualized as an input. The dashboard display unit outputs a data set filtered according to the role. The dashboard display unit outputs a vector graphics drawing command. The dashboard display unit detects a drill-down operation and a slicing operation by the user. The dashboard display unit executes a re-query of data in accordance with the operation. The dashboard display unit prevents information overload. The dashboard display unit provides insights optimized for each stakeholder. The dashboard display unit accelerates data-driven decision-making.

When a serious bias or legal regulation violation is detected, the alert notification unit immediately notifies related parties by various means such as a pop-up notification, an email notification, a chat notification, and a smartphone push notification on the terminal side. For example, it automatically issues an alert such as “Immediate response is required because service provision to a minor is detected”, “Execute an emergency review because a rejection rate of female applicants exceeds a specified value”, and “New input control is required due to legal regulation revision”. The notification content is described in detail including an occurrence date and time, a target AI system, a detection content, a recommended response measure, a past similar case, and the like. Specifically, the alert notification unit executes a dedicated importance determination neural network to determine an urgency of the notification and an optimal transmission route. The neural network adopts a transformer architecture. The processing unit tokenizes evaluation result texts output from the compliance evaluation unit and the bias detection unit by natural language processing. The processing unit converts the tokenized data into a 512-dimensional word embedding vector. The processing unit inputs the word embedding vector to the importance determination neural network. Specific examples of the input data include a one-hot vector of a categorical variable indicating a violation type, a normalized floating-point number indicating an occurrence frequency, and a cosine similarity score with a past similar case. The neural network calculates a dependency relationship between input vectors using a self-attention mechanism. The neural network outputs an importance score taking a continuous value in a range of 0.0 to 1.0. Specific examples of the output data include a score of 0.95 for a service provision violation to a minor, or a score of 0.12 for a minor notation fluctuation. The alert notification unit compares the output importance score with a plurality of preset thresholds. The alert notification unit executes a branch process of immediate push notification and emergency email transmission when the score is 0.8 or more. The alert notification unit executes an addition process to a daily report when the score is 0.5 or more and less than 0.8. The system uses such vector calculation in a high-dimensional space and dynamic threshold determination. The system eliminates a conventional work in which a human administrator manually monitors logs. The system reduces a notification delay to a millisecond unit. The system exhibits a technical effect of preventing an oversight of an important alert. The system is extremely effective in a use case where rapid abnormality detection is required, such as a compliance department of a financial institution and a safety management department of a medical institution.

The user feedback management unit enables a user on the terminal side to input a response status to a proposal content, an additional comment, an operational notice, an improvement request, and the like through the dashboard and the alert notification, and centrally manages these pieces of information on the server side. For example, it records feedback such as “Proposed data expansion has been implemented”, “Additional development is requested for new legal regulation compliance”, and “Re-evaluation of bias detection result is requested”, and makes them referable and analyzable later in cooperation with the history management unit. Specifically, the user feedback management unit includes a natural language processing module configured to convert the input feedback text in a natural language into structured data. The module analyzes the text using a pre-trained language model. The module converts the input text into a 768-dimensional dense vector tensor. Specific examples of the input data include a character code array of a character string input by the user, an integer value of a UNIX time stamp indicating an input time, and an identifier of a target alert ID. The module inputs the dense vector tensor to a support vector machine-based classification algorithm. The classification algorithm classifies the content of the feedback into a plurality of predefined categories. The classification algorithm outputs a probability distribution belonging to each category. Specific examples of the output data include a probability value of 0.88 for a data expansion completion category, or a probability value of 0.75 for a re-evaluation request category. The user feedback management unit assigns a category having the highest probability value as an attribute of the feedback. The user feedback management unit automatically transfers the attribute information to a subsequent re-learning data pipeline. The system also executes a regression model for extracting an emotion score from the feedback text in parallel. The regression model digitizes an urgency and a dissatisfaction degree of the user in a range of minus 1.0 to plus 1.0. The system executes a branch process of inserting the feedback into a priority processing queue when the extracted emotion score falls below minus 0.5. The system uses such vectorization of a natural language and automatic classification processing by machine learning. The system eliminates an inefficient work in which a human manually classifies and aggregates feedback. The system exhibits a technical effect of dramatically improving data collection efficiency for system improvement. The system is particularly useful in a use case where a large amount of user opinions needs to be processed rapidly, such as a large-scale customer support center and an internal help desk.

Specific examples of a prompt sentence to be read by the generative AI necessary for carrying out the present invention include, for example, “Refer to the following AI system operation log and the latest laws, regulations, and guidelines, determine in detail whether there is a regulation violation or a guideline deviation, and explain the basis thereof”, “Analyze the following operation log for each attribute, and explain the tendency and cause in detail if bias exists”, “Generate a plurality of corrective measure proposals based on the following bias detection result and compliance violation content, and explain the effect and implementation procedure of each in detail”, and “Analyze the following history data in chronological order, and graph the implementation effect and improvement tendency of the corrective measure”. Specifically, the system includes a prompt engineering module configured to convert these prompt sentences not as simple character strings but into a structured input tensor that can be efficiently processed by a large language model. The module divides the prompt sentence into three segments: a system instruction, context data, and a task request. The module assigns a specific control token to each segment. The module converts the divided text into an integer token ID array using a byte pair encoding algorithm. Specific examples of the input data include a 1024-dimensional token array obtained by converting a JSON format character string of the operation log, a summary vector of a legal regulation text, and a metadata tensor specifying an output format. The system supplies these pieces of input data to an input layer of the large language model. The large language model is composed of a transformer network having tens of billions of parameters. The large language model calculates a self-attention weight of the input token array. The large language model autoregressively predicts a probability distribution of a next appearing word. The large language model outputs a token ID array of the generated text. Specific examples of the output data include a Boolean token indicating presence or absence of a violation, a token array of a natural language text explaining a basis of the violation, and structured data in a bulleted list format indicating steps of a corrective measure. The system inputs the output token ID array to a decoder module. The decoder module reversely converts the token ID array into a human-readable text character string. The system executes a subsequent process of extracting a specific data item from the reversely converted text using a regular expression. The system uses such highly structured prompt generation and token-level control. The system suppresses hallucination of the output of the large language model. The system exhibits a technical effect of significantly improving accuracy and consistency of an inference result. The system is extremely effective in a use case where high accuracy is required, such as contract examination support by a legal department and automation of a compliance check by an audit department.

As described above, the system according to the present embodiment has an extremely advanced and practical configuration in which the operation monitoring unit, the compliance evaluation unit, the bias detection unit, the correction proposal unit, the history management unit, the dashboard display unit, the alert notification unit, and the user feedback management unit cooperate with each other, and generative AI is set as a core to enable securing of transparency, fairness, and legal compliance of the AI system in real time and autonomously. Specifically, the system adopts a microservice architecture in which each of these processing units is deployed on a virtualized environment as an independent container. The system executes data communication between the respective processing units via an asynchronous messaging queue. The system serializes log data generated by the operation monitoring unit into binary data in a protocol buffer format. The system publishes the serialized data to a specific topic of the messaging queue. In the system, the compliance evaluation unit and the bias detection unit subscribe to the topic. The system deserializes the received binary data and expands it on a memory. The system implements an orchestration engine in which each processing unit can scale independently. The system dynamically allocates a calculation resource according to a load status of the entire system. The system utilizes a dedicated tensor processing unit to speed up inference processing of the generative AI. The system compresses a weight parameter of an inference model into a 16-bit floating-point format by a quantization technology. The system maximizes parallel calculation efficiency while suppressing consumption of a memory bandwidth. The system uses such a distributed processing architecture and hardware-level optimization. The system eliminates a single point of failure. The system exhibits a technical effect of enabling real-time compliance evaluation for tens of thousands of log data per second. The system becomes an indispensable base technology in a use case where extremely high throughput and availability are required, such as a large-scale e-commerce platform deployed globally and content moderation of social media having millions of users.

### Implementation Steps

Step 1: Real-time Collection of Operation Logs Every time the AI system receives an input from a user and makes a decision or an output, detailed operation logs such as input data (age, gender, occupation, region, past transaction history, examination data, inquiry content, and the like), an output result of the AI (approval/rejection, diagnosis name, response content, pass/fail decision, and the like), a score and a feature amount used for the decision, a version of an AI model, an inference time, a person-in-charge ID, and an ID of a referenced past case or guideline are acquired on the terminal side, transmitted to the server side in real time by encrypted communication, and accumulated in a database on the server side in chronological order. It corresponds to various industries and applications such as finance, medical care, communication, and human resources, and comprehensively collects data items specific to each industry. Specifically, the system makes a lightweight edge agent program resident on the terminal side. The edge agent monitors a process of the AI system at a kernel level of an operating system. The edge agent directly hooks and acquires an input/output tensor expanded on a memory by the AI system. The edge agent converts the acquired raw data into a structured JSON format payload. The edge agent identifies personal information and confidential data in the payload. The edge agent executes a pre-process of anonymizing the identified data using an irreversible hash function. Specific examples of the input data include an integer value indicating a user's age, a time-series floating-point array representing a past transaction history, and a 256-dimensional feature vector extracted from a medical image. The edge agent encrypts the pre-processed payload using an advanced encryption standard algorithm. The edge agent transmits the encrypted data to the server via a secure transport layer protocol. A receiving module on the server side decrypts the received data. The receiving module on the server side writes the data into an in-memory time-series database. The time-series database adopts a column-oriented storage engine using a time stamp as a primary key. The system uses such data extraction and anonymization processing on the edge side. The system minimizes consumption of a network bandwidth. The system exhibits a technical effect of fundamentally eliminating a security risk during data transfer. The system is extremely effective in a use case where data integrity and confidentiality are given top priority, such as a remote medical diagnosis system requiring strict privacy protection and a fraud detection system for highly confidential financial transactions.

Step 2: Automatic Acquisition and Analysis of Laws, Regulations, and Guideline Information On the server side, latest regulation information and guideline documents are automatically acquired from an external legal regulation database or an industry guideline API periodically or in real time, read into generative AI, and analyzed by natural language processing. For example, various regulations and guidelines are targeted, such as a new lending restriction in the financial industry, a diagnosis procedure change in the medical field, a service provision restriction in the communication industry, and a selection standard revision in the human resources field. A specific example of a prompt sentence to be read by the generative AI includes “Analyze the following laws, regulations, and guideline documents, extract requirements, prohibited matters, and standards to be complied with that affect AI system operation, and summarize them”. Specifically, the system executes a distributed web crawler module for collecting information from an external data source. The crawler module analyzes a document object model of a target website. The crawler module differentially extracts only an updated text node. The system inputs the extracted text data to a natural language processing pipeline. The pipeline divides the text into sentence units. The pipeline executes stop word removal and stemming processing. The system inputs the pre-processed text to a large language model. Specific examples of the input data include a character string of an official gazette text of a law revision, a paragraph text extracted from a PDF of a guideline, and metadata indicating an update date and time. The large language model identifies an entity and a conditional expression subject to regulation from the input text using a named entity extraction algorithm. The large language model outputs the extracted requirements as nodes and edges of a structured knowledge graph. Specific examples of the output data include a node of a numerical condition indicating an age limit, an action node indicating a prohibited act, and edge data indicating a relationship connecting them. The system executes a subsequent process of storing the output knowledge graph data in a vector database. The system converts text information of each node into an embedding vector and indexes it. The system uses such automated crawling and knowledge graph construction processing. The system eliminates a complicated work in which a human manually confirms a change in laws and regulations and reflects it in the system. The system exhibits a technical effect of dramatically improving a tracking speed of the system to a regulation change. The system is particularly useful in a use case such as compliance management in a fintech area where law revisions are frequently made, and a global supply chain management system that needs to comply with different regulations of each country.

Step 3: Transparency Evaluation of Operation Logs and Basis Explanation Generation On the server side, the collected operation logs are input to generative AI, and an explanation text of a basis of each decision and a decision-making process is automatically generated. For example, it generates an explanation that enhances transparency of a decision, such as “This credit examination was approved on the basis that the age is 35, the credit score is 750, there is no delinquency history in the past three years, and the application amount is 1 million yen or less”. In the medical field, it generates an explanation such as “The patient was diagnosed with suspected lung cancer because the patient was a 60-year-old male, a nodular shadow was observed in a lung field in a chest X-ray image, and a tumor marker value exceeded a reference value”. A specific example of a prompt sentence to be read by the generative AI includes “Explain a basis of each decision and a decision-making process in detail based on the following AI system operation log”. Specifically, the system executes an explainable AI module for making an internal state of a black-boxed AI model interpretable. The module calculates a contribution degree of each feature amount in an inference process of a target AI model. The module calculates a marginal contribution degree for each input feature amount using a Shapley additive explanation algorithm. The system combines the calculated contribution score and the original input data to construct an input tensor for explanation generation. Specific examples of the input data include a contribution score of 0.45 for an age feature amount, a contribution score of 0.60 for a credit score feature amount, and their original numerical data. The system inputs the input tensor to a transformer model specialized for natural language generation. The model adopts an encoder-decoder architecture. The model preferentially captures a feature amount having a high contribution degree by an attention mechanism. The model outputs a text having a logical sentence structure that is easy for a human to understand. Specific examples of the output data include a character string of an explanation text having a feature amount with the highest contribution degree as a subject, a percentage value indicating a certainty degree of a decision, and a text of a counterfactual explanation indicating an alternative scenario. The system executes a subsequent process of binding the output explanation text to a user interface component of the dashboard. The system uses such integrated processing of mathematical calculation of a feature amount contribution degree and natural language generation. The system realizes dynamic and accurate basis presentation different from simple template-based sentence generation. The system exhibits a technical effect of improving user's reliability on an AI decision based on a mathematical basis. The system is extremely effective in a use case where high transparency is required, such as an automatic loan examination system in which explanation of a decision basis is legally obligated, and a medical image diagnosis system supporting a final decision of a doctor.

Step 4: Bias Detection and Tendency Analysis On the server side, operation logs are input to generative AI, an output tendency of the AI is analyzed statistically and by machine learning for each of various attributes such as age, gender, region, occupation, disease, contract plan, educational background, and place of origin, and presence or absence, a tendency, a cause, and a scope of impact of bias are automatically detected and explained. For example, it extracts “a rejection rate of female applicants is 10% higher than that of male applicants”, “there is a specific bias in a diagnosis result of an elderly person”, “a satisfaction degree of an FAQ response is low for a user in a specific region”, and the like, and explains why the bias occurs. A specific example of a prompt sentence to be read by the generative AI includes “Analyze the following operation logs for each attribute, and explain a tendency and a cause thereof in detail if bias exists”. Specifically, the system executes a bias analysis engine for quantifying a bias of data distribution in a multidimensional feature space. The engine divides a data set of the collected operation logs into a protected attribute and a non-protected attribute. The engine calculates a statistical parity difference and an equalized odds difference between respective attribute groups. The system executes propensity score matching using a logistic regression model to calculate these fairness indicators. Specific examples of the input data include a multidimensional matrix including tens of thousands of user profiles, a vector of a binary classification result of AI for each user, and a binary mask tensor specifying a protected attribute. The engine determines that bias exists when the calculated fairness indicator exceeds a preset allowable threshold. The system inputs the determination result and statistical data to a large language model. The large language model estimates a root cause of the bias using a causal inference algorithm. The large language model outputs a type of bias, an occurrence mechanism, and a degree of impact on business in a structured report format. Specific examples of the output data include a floating-point number indicating a difference in approval rate by gender, a text pointing out a sample shortage of a specific class in training data, and an estimated value of a potential economic loss caused by bias. The system executes a subsequent process of transferring the output report to the correction proposal unit and firing an automatic model re-learning trigger. The system uses such a combination of strict statistical indicator calculation and causal inference. The system accurately identifies a hidden bias in a high-dimensional space that is difficult to notice by human intuition. The system exhibits a technical effect of objectively and quantitatively securing fairness of a machine learning model. The system is an indispensable technology in a use case where an algorithm bias has a risk of directly leading to a serious human rights violation, such as an automatic screening system for employment candidates and a crime prediction algorithm.

Step 5: Compliance Evaluation and Violation Determination On the server side, the operation log and the analyzed laws, regulations, and guideline information are input to the generative AI, whether each decision and output of the AI system complies with the latest laws, regulations, and guidelines is automatically determined, and if there is a violation, its content and basis are explained in detail. For example, it determines “violation of prohibition of credit to persons under 18 years old”, “violation of age restriction for prescription of specific drug”, “conflict with prohibition of service guidance to minors”, and the like, and also explains the basis of the violation and the scope of impact. As a specific example of a prompt sentence to be read by the generative AI, “Collate the following AI system operation log with the laws, regulations, and guideline requirements, point out in detail if there is any violation or deviation, and explain the basis thereof” can be cited. Specifically, the system executes a hybrid inference engine for collating dynamically changing legal regulation rules with real-time system behavior. The engine adopts an architecture combining a decision tree-based rule engine and a large language model. The system extracts legal regulation rules related to the current context from the knowledge graph constructed in Step 2 by vector similarity search. The system inputs the extracted rules and the data of the operation log to the hybrid inference engine. Specific examples of the input data include a state vector including a user's age and a transaction amount, syntax tree data of a logical expression representing a conditional expression of a legal regulation, and an embedding vector of a past violation case. The engine first filters violations of clear numerical conditions at high speed using the rule engine. The engine then executes context-dependent complex violation determination using the large language model. The large language model calculates a probability that the input log violates each legal regulation category using a zero-shot classification method. The large language model outputs a flag indicating presence or absence of a violation, an identifier of a specific violated article, and a text indicating a logical inference process of the violation. Specific examples of the output data include a truth value indicating an age restriction violation, a character string indicating which article and paragraph of the corresponding law, and a severity score of a legal penalty due to the violation. The system transmits the output violation determination result to an alert notification unit, and executes a subsequent process of instructing an immediate stop of the system or a transition to a fail-safe mode. The system uses such a hybrid approach of rule-based and machine learning. The system flexibly detects violations of unknown patterns while minimizing false positives. The system exhibits a technical effect of preventing legal risks due to compliance violations. The system is extremely effective in use cases such as content distribution control of a healthcare application involving complex pharmaceutical and medical device act regulations, and access control of a cloud service that needs to comply with different data protection rules of each country.

Step 6: Autonomous Generation and Presentation of Correction Proposal On the server side, the analysis results of the bias detection unit and the compliance evaluation unit are input to the generative AI, and when bias or a legal regulation violation is detected, a plurality of corrective measures according to a situation, such as expansion of training data, introduction of an attribute bias reduction algorithm, enhancement of input control or an output filter, re-learning of an AI model, modification of a decision-making logic, review of an operation process, and introduction of a double check system, are autonomously generated, and presented on a dashboard including their effects and implementation procedures. As a specific example of a prompt sentence to be read by the generative AI, “Based on the following bias detection result and compliance violation content, generate a plurality of corrective measure proposals, and explain the effect and implementation procedure of each in detail” can be cited. Specifically, the system executes a reinforcement learning-based proposal generation module for searching for an optimal solution to the detected problem. The module defines a past failure response history and system configuration information as a state space. The module defines a combination of possible corrective measures as an action space. The system inputs the bias detection result and metadata of the compliance violation to the proposal generation module. Specific examples of the input data include an integer value from 0 to 10 indicating the severity of the violation, a floating-point number representing the number of affected users, and an array of hyperparameter setting values of the current AI model. The module calculates an expected reward when each corrective measure is executed using a Markov decision process model. The module searches for a sequence of corrective measures that maximizes the expected reward by a Viterbi algorithm. The module inputs the searched sequence of corrective measures to the large language model, and converts it into a specific procedure manual text executable by a human. The module outputs a plurality of corrective measure options, their respective estimated implementation costs, and predicted values of expected improvement effects. Specific examples of the output data include a source code snippet of a data expansion script, a numerical value indicating an estimated time of computational resources required for re-learning, and a data array for graph drawing of a simulation result of a bias reduction effect. The system executes a subsequent process of transmitting the output proposal data to a front-end application of the dashboard in a JSON format. The system uses such a fusion of optimization search by reinforcement learning and natural language generation. The system significantly reduces the time for a human to formulate a countermeasure based on a rule of thumb. The system exhibits a technical effect of dramatically shortening a lead time for system recovery and improvement. The system is particularly useful in use cases such as failure response support of a mission-critical financial transaction system and automatic tuning of a large-scale machine learning pipeline.

Step 7: History Management and Time-Series Analysis On the server side, all monitoring results, bias detection results, compliance evaluation results, correction proposal contents, user feedback, response statuses, and the like are centrally managed in chronological order, and implementation histories and improvement effects of past corrective measures, response histories at the time of regulation revision, evaluation histories at the time of AI model version upgrade, and the like are accumulated and analyzed. For example, a history such as “laws and regulations were revised on Jun. 1, 2024, and new input control was introduced from the next day” is recorded in detail so that it can be searched, referred to, and analyzed later. As a specific example of a prompt sentence to be read by the generative AI, “Analyze the following history data in chronological order, and graph the implementation effect and improvement tendency of the corrective measure” can be cited. Specifically, the system constructs a distributed time-series database cluster for efficiently processing a huge amount of history data. The database cluster adopts a log-structured merge-tree optimized for data write performance. The system sorts event logs asynchronously transmitted from each processing unit in order of time stamp and persists them in a storage. The system executes a recurrent neural network model using a long short-term memory network in order to analyze the accumulated time-series data. Specific examples of the input data include a time-series array of daily bias scores for the past year, a binary vector indicating an execution flag of a system update, and categorical data of a legal regulation change event. The neural network model learns a delayed effect of an influence of a past event on a current system state while updating a hidden state of the input time-series data. The neural network model outputs a transition prediction of a future bias score and an estimated value of a long-term improvement effect brought about by a specific corrective measure. Specific examples of the output data include prediction curve data of a compliance violation occurrence probability for the next 30 days, a numerical score indicating a return on investment of a past corrective measure, and an array of frequency components indicating seasonality and periodicity. The system executes a subsequent process of passing the output analysis result to a data visualization library and generating an interactive chart. The system uses such advanced time-series data modeling and predictive analysis. The system enables data-driven proactive system operation, not just an enumeration of past records. The system exhibits a technical effect of predicting and avoiding a future compliance risk in advance. The system is extremely effective in use cases such as a continuous integration environment of an autonomous driving algorithm requiring long-term quality assurance, and a monitoring system of an ESG evaluation index of a company.

Step 8: Dashboard Display and Alert Notification On the terminal side, the monitoring result, the bias detection status, the compliance evaluation result, the correction proposal content, the history information, and the like received from the server are visualized in real time, and summary information is displayed for management, and detailed proposals and histories, graphs and tables, time-series charts, and the like are displayed from multiple angles for engineers. When a serious bias or legal regulation violation is detected, related parties are immediately notified by various means such as a pop-up notification, an email notification, a chat notification, and a push notification of a smartphone, and the notification content is described in detail including an occurrence date and time, a target AI system, a detection content, a recommended countermeasure, a past similar case, and the like. Specifically, the system implements a high-performance front-end drawing engine using WebAssembly technology on the terminal side. The drawing engine establishes a full-duplex communication channel by a WebSocket protocol with the server. The system push-distributes the analysis result and alert data generated on the server side to the terminal side as a payload in a binary format. The drawing engine immediately decodes the received payload on a memory on the client side. The drawing engine updates a user interface while minimizing redrawing of a screen using a differential update algorithm of a virtual document object model. Specific examples of the input data include a stream of floating-point numbers indicating a real-time bias score, a coordinate data array for graph drawing, and an integer value indicating a user's authority level. The drawing engine dynamically switches a component to be displayed according to the user's authority level. The drawing engine renders a summary widget of a key performance indicator for management, and renders a data grid of a raw log and a heat map indicating a weight distribution of a model for engineers. When receiving a serious alert, the system calls a native notification API of an operating system. The system forcibly displays a modal dialog on the forefront of the screen. Specific examples of the output data include a time-series chart in an SVG format rendered on the screen, a text message registered in a notification center, and a playback command of an alert sound. The system executes a subsequent process of transitioning to a corresponding detailed analysis screen by a deep link when the user clicks the notification. The system uses such real-time communication and optimized drawing processing on the client side. The system prevents freezing of the screen even under a situation where a large amount of data update occurs. The system exhibits a technical effect of providing a user with intuitive situation grasping without delay. The system is an indispensable technology in use cases such as an integrated operation center that monitors operation statuses of a plurality of systems, and a cybersecurity monitoring dashboard that requires an emergency response.

Step 9: Collection and Management of User Feedback On the terminal side, a user is enabled to input a response status, an additional comment, an operational notice, an improvement request, and the like to the proposal content through the dashboard or the alert notification, and such information is centrally managed on the server side and can be referred to and analyzed later in cooperation with the history management unit. For example, feedback such as “proposed data expansion has been implemented”, “requested additional development for new legal regulation compliance”, and “requested re-evaluation of bias detection result” is recorded. Specifically, the system captures a user's input through a rich text editor component incorporated in the user interface on the terminal side. The component monitors a user's keystroke event. The component executes an auto-save function of asynchronously transmitting the input text data to the server at regular intervals. The system inputs the feedback text received on the server side to a natural language processing pipeline. The pipeline extracts a main keyword and intention from the text using a topic model. Specific examples of the input data include a character string of a natural language input by the user, a character string indicating a screen ID of an input source, and a unique identifier of a target alert. The system inserts the extracted intention vector and the original text data into a feedback table of a relational database. The system joins the feedback data and the time-series data of the history management unit by a foreign key constraint. The system automatically updates a data set for fine-tuning of the AI model based on the content of the feedback. When the user inputs an intention of “requested re-evaluation”, the system labels the corresponding log data as a false positive sample. The system moves the labeled data to an input directory of a re-learning pipeline. Specific examples of the output data include a record set of the feedback recorded in the database, a probability distribution vector of the extracted topic, and a file path of the updated learning data set. The system executes a subsequent process of notifying the user of the result after the execution of the re-learning pipeline is completed. The system uses such automatic analysis of feedback and integration processing into a learning loop. The system directly reflects human tacit knowledge obtained through system operation in improvement of a machine learning model. The system exhibits a technical effect of continuously improving accuracy of the system and user satisfaction. The system is extremely effective in use cases such as a medical diagnosis support system that needs to continuously incorporate expert knowledge, and a personalized recommendation engine that evolves according to user preferences.

### Specific Use Case

For example, when the system of the present invention is applied to an operation site of a credit examination AI system in the financial industry, the operation monitoring unit collects all operation logs related to credit examination, such as an age, a gender, an occupation, a residential area, an application amount, a past transaction history, a credit score of an examination applicant, an examination time, an examiner ID, a version of an AI model, a value of a feature amount used for inference, an output result (approval/rejection) of the AI, an output certainty score, and an ID of a past case referred to by the AI, in real time, and transmits them to the server side. The compliance evaluation unit automatically acquires latest regulation information such as “prohibition of credit to persons under 18 years old”, “restriction on lending to specific occupation”, and “prohibition of service provision to antisocial forces” from an external legal regulation database or an industry guideline API, causes the generative AI to read it, and analyzes the content. The bias detection unit inputs the operation log to the generative AI, analyzes an output tendency of the AI for each of various attributes such as age, gender, region, and occupation statistically and by machine learning, extracts a bias tendency such as “a rejection rate of female applicants is 10% higher than that of male applicants” and “an approval rate is remarkably low for applicants in a specific region”, and explains its cause and scope of impact in a natural language. The compliance evaluation unit inputs the operation log and the analyzed laws, regulations, and guideline information to the generative AI, automatically determines whether each decision and output of the AI system complies with the latest laws, regulations, and guidelines, determines “violation of prohibition of credit to persons under 18 years old”, “violation of restriction on lending to specific occupation”, and the like, and also explains the basis of the violation and the scope of impact. When bias or a legal regulation violation is detected, the correction proposal unit autonomously generates a plurality of corrective measures according to a situation, such as “increase the number of female samples in training data”, “introduce an attribute bias reduction algorithm”, “enhance an age check function of input data”, and “automatically exclude users in a specific region”, using the generative AI, and presents them on the dashboard including their effects and implementation procedures. The history management unit centrally manages all monitoring results, bias detection results, compliance evaluation results, correction proposal contents, user feedback, response statuses, and the like in chronological order, and accumulates and analyzes implementation histories and improvement effects of past corrective measures, response histories at the time of regulation revision, evaluation histories at the time of AI model version upgrade, and the like. A dashboard display unit visualizes the monitoring result, the bias detection status, the compliance evaluation result, the correction proposal content, the history information, and the like received from the server in real time on the terminal side, and displays summary information for management, and detailed proposals and histories, graphs and tables, time-series charts, and the like from multiple angles for engineers. When a serious bias or legal regulation violation is detected, the alert notification unit immediately notifies related parties by various means such as a pop-up notification, an email notification, a chat notification, and a push notification of a smartphone, and the notification content is described in detail including an occurrence date and time, a target AI system, a detection content, a recommended countermeasure, a past similar case, and the like. The user feedback management unit enables a user to input a response status, an additional comment, an operational notice, an improvement request, and the like to the proposal content through the dashboard or the alert notification on the terminal side, centrally manages such information on the server side, and makes it possible to refer to and analyze it later in cooperation with the history management unit. Specifically, the system executes a dedicated data integration pipeline tightly coupled with a core system of a financial institution. The pipeline directly captures a feature amount tensor on a memory every time the credit examination AI executes inference. The system converts the captured multidimensional tensor into a standardized vector format for compliance evaluation. Specific examples of the input data include a one-hot encoding vector of a categorical variable indicating an applicant's attribute, an array of normalized continuous values indicating a credit score and an application amount, and an output value tensor of an activation function in each layer of an inference model. The system inputs these input data in parallel to a plurality of dedicated neural network models arranged on the server side. The system executes a simulation using a generative adversarial network in the bias detection unit. The simulation generates virtual input data in which a specific protected attribute is inverted, and quantitatively measures how the output of the AI model changes. The system calculates a cosine similarity between an embedding vector of a legal regulation text and an embedding vector of the operation log using a natural language processing model in the compliance evaluation unit. The system sets a violation flag when the similarity exceeds a threshold value. Specific examples of the output data include a floating-point number indicating a bias amplification rate for each attribute, a score from 0 to 1 indicating a probability of a legal regulation violation, and a JSON object including an execution script of a corrective measure. The system integrates these output results, and executes a subsequent process of calculating an optimal parameter adjustment value using a reinforcement learning algorithm in the correction proposal unit. The system uses such tensor calculation in a high-dimensional space and ensemble inference of a plurality of models. The system monitors a behavior of a complex financial algorithm, which is impossible for a human to visually confirm, in units of milliseconds. The system exhibits a technical effect of automatically satisfying strict audit requirements required by a regulatory authority such as the Financial Services Agency. The system becomes an indispensable fundamental technology in financial use cases requiring extremely high reliability and fairness, such as a real-time fraud detection system for credit cards that processes millions of transactions, and an online lending platform that dynamically determines an interest rate.

Specific examples of prompt sentences to be read by the generative AI include “Refer to the following operation log of the credit examination AI system and the latest laws, regulations, and guidelines, determine in detail whether there is any regulation violation or guideline deviation, and explain the basis thereof”, “Analyze the following operation log for each attribute, and if bias exists, explain its tendency and cause in detail”, “Based on the following bias detection result and compliance violation content, generate a plurality of corrective measure proposals, and explain the effect and implementation procedure of each in detail”, and “Analyze the following history data in chronological order, and graph the implementation effect and improvement tendency of the corrective measure”. Specifically, the system converts these prompt sentences specialized for the financial domain into a context expansion tensor for maximizing inference accuracy of the large language model. The system divides the text of the prompt sentence into an integer token ID array using a subword tokenizer. The system adds a positional encoding vector to each token to retain order information of an input sequence. Specific examples of the input data include a token array in which numerical values of the credit examination log are converted into character strings, a token array of a specific article of the Financial Services Agency guidelines, and a token array of a system prompt specifying constraint conditions of a task. The system combines these token arrays and supplies them to an input layer of a transformer-based large language model. The large language model calculates a relevance between a specific numerical value in the operation log and a conditional expression in the legal regulation text using a multi-head attention mechanism. The large language model autoregressively generates a logical inference step after understanding a context of financial technical terms. Specific examples of the output data include a classification token indicating a conclusion of violation determination, a text token array of an intermediate step indicating a chain of inference, and a comma-separated data character string for graph drawing. The system inputs the output text to a syntax analyzer, and executes a subsequent process of converting it into a command or a setting file automatically executable by the system. The system uses such domain-specialized prompt engineering and optimization of attention weights. The system causes a general-purpose language model to function as an advanced financial compliance expert. The system exhibits a technical effect of dramatically improving accuracy and consistency of determination for complex financial regulations. The system is extremely effective in use cases requiring specialized domain knowledge and strict logical inference, such as an audit system for algorithmic trading and an automatic assessment system for insurance money.

### Application Example 1

The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail.

The autonomous driving AI governance support system of the present invention is composed of a server, a vehicle terminal, and an external database group. The server is installed in a cloud environment or a dedicated data center, and bears central functions such as advanced data analysis, determination by generative AI, history management, dashboard generation, and alert issuance. The vehicle terminal is mounted on an autonomous driving vehicle, and has functions of sensor data acquisition, real-time log generation, initial abnormality detection, communication with the server, and partial emergency notification. The external database group covers a wide range, such as a traffic legal regulation database, a regional driving rule API, a weather information API, a past accident database, a road construction information database, and an emergency vehicle operation information API. Specifically, the system constructs a distributed computing architecture between the vehicle terminal and the server. The system arranges an edge computing node on the vehicle terminal side. The edge computing node is directly connected to a controller area network bus of the vehicle. The edge computing node samples raw data output from each sensor at a cycle in units of milliseconds. The edge computing node integrates the sampled data into a multidimensional tensor. Specific examples of the input data include an RGB image tensor of 1080p resolution from a camera, a three-dimensional point cloud data array from LiDAR, and a floating-point vector of latitude and longitude coordinates from a GPS. The edge computing node executes a lightweight convolutional neural network on these input data to perform initial feature extraction and abnormality detection. The edge computing node packetizes the extracted feature amount vector and a control command of the vehicle. The edge computing node transmits data to the server using a low-latency slice of a 5G network. On the server side, the received packet is expanded into an in-memory data grid. On the server side, environmental context data acquired from the external database group via a RESTful API and vehicle data are combined. Specific examples of the output data include traffic regulation polygon data around a current position of the vehicle, a categorical variable indicating a real-time weather condition, and a heat map tensor indicating a past accident occurrence probability. The system executes a subsequent process of routing the combined data to an input queue of the subsequent compliance evaluation unit and bias detection unit. The system uses such cooperative processing of edge and cloud and integration of multimodal data. The system realizes advanced analysis utilizing huge computational resources on the cloud side while reducing a calculation load on the vehicle side. The system exhibits a technical effect of monitoring and evaluating safety of the autonomous driving system in real time. The system becomes an indispensable fundamental technology in mobility use cases requiring extremely high safety and responsiveness, such as fully autonomous robotaxi fleet management and operation monitoring of long-distance autonomous driving trucks.

First, the operation monitoring unit is mounted on a vehicle terminal. Here, all data obtained from a camera, LiDAR, a radar, a GPS, an IMU, an ultrasonic sensor, a microphone, a temperature sensor, a humidity sensor, a tire pressure sensor, a vehicle control unit, and the like are integrated, and every time the AI makes a driving decision, position information during driving (latitude, longitude, altitude, road type, and intersection ID), current speed, acceleration, traveling direction, lane position, attributes (type, age estimation, gender estimation, operation state, distance, relative speed, traveling direction, and presence or absence of walking aid) of surrounding detected objects (a pedestrian, a bicycle, a motorcycle, another vehicle, a traffic light, a sign, an animal, an obstacle, a stroller, a wheelchair, a person pushing a stroller, a pedestrian with a white cane, a pedestrian accompanied by a guide dog, and the like), a decision content made by the AI (deceleration, stop, avoidance, acceleration, course change, warning issuance, doing nothing, horn, light turning on, blinker blinking, emergency braking, lane departure warning, inter-vehicle distance adjustment, engine output control, and the like), a certainty score of the decision, a version of the AI model being used, a decision time, weather information (clear weather, rain, snow, fog, strong wind, road freezing, road wetness, poor visibility, and the like), road surface conditions (dry, wet, frozen, gravel, step, hole, under construction, and presence or absence of falling object), traffic volume, vehicle states (brake pressure, accelerator opening degree, steering wheel angle, blinker state, light state, tire pressure, remaining battery level, engine temperature, cooling water temperature, remaining fuel level, vehicle weight, and load information), past cases and traffic rule IDs referred to by the AI, emergency vehicle approach information, road construction information, traffic jam information, accident occurrence information, road closure information, event holding information, school vicinity information, nursery school vicinity information, hospital vicinity information, nursing home vicinity information, and the like are generated as a detailed driving log in real time and transmitted to the server. For example, when an elderly pedestrian is detected at an intersection in an urban area, the AI makes a “deceleration” decision, and records information such as “pedestrian's age estimation 75 years old, distance 10 meters, on a pedestrian crossing, traffic light green, 3 other pedestrians around, weather is rain, road surface wet, vehicle speed 30 km/h” as a basis thereof. For example, when an animal (deer) is detected on a suburban road at night, the AI makes a “deceleration/warning issuance” decision, and records an animal type, a distance, surrounding brightness, a vehicle light state, a past similar case ID, a road type (mountain road), a road width, presence or absence of a guardrail, speed limit sign information, and the like. For example, when a bicycle is detected in rainy weather, the AI makes a “course change” decision, and records weather, a road surface state, a traveling direction of the bicycle, a speed difference, a lane position of the bicycle, presence or absence of light turning on of the bicycle, presence or absence of helmet wearing of the bicycle, and the like. For example, when a sudden stop of a preceding vehicle is detected during a traffic jam, the AI makes an “emergency braking” decision, and records a distance to the preceding vehicle, a relative speed, a brake pressure, presence or absence of ABS operation, a distance to a following vehicle, a speed of the following vehicle, vehicle load information, and the like. For example, when a group of children is detected in a school zone, the AI makes a “slow driving” decision, and records the number of children, age estimation, spread of the group, walking speed, presence or absence of surrounding guardians, a traffic light state, presence or absence of a pedestrian crossing, sign information, a time zone (when going to and from school), weather, a road surface state, and the like. Specifically, the operation monitoring unit executes a sensor fusion algorithm that temporally and spatially synchronizes asynchronous data streams from heterogeneous sensors. The operation monitoring unit reduces observation noise of each sensor using a Kalman filter, and estimates state vectors of the vehicle and surrounding objects. The operation monitoring unit combines the estimated state vectors and internal parameters of the autonomous driving AI to construct a high-dimensional context tensor. Specific examples of the input data include a coordinate matrix of a bounding box extracted from a LiDAR point cloud, a class label matrix in units of pixels extracted from a camera image by semantic segmentation, and a time-series numerical array indicating a steering angle and a brake pressure of the vehicle. The operation monitoring unit inputs these input data to a serialization module. The serialization module encodes the data into a protocol buffer format which is an efficient binary format. The operation monitoring unit adds a hash-based message authentication code to the encoded data to prevent falsification of the data. Specific examples of the output data include a binary payload of several hundred kilobytes to which a time stamp is added, a checksum value indicating completeness of the data, and a flag indicating a transmission priority. The operation monitoring unit executes a subsequent process of publishing the output payload to a broker on the server side using a message queuing telemetry transport protocol. The system uses such advanced sensor fusion and efficient data serialization processing. The system transfers a huge amount of sensor data to a cloud in real time without straining a network bandwidth. The system completely visualizes a black-boxed decision-making process of the autonomous driving AI, and exhibits a technical effect of enabling ex-post verification. The system is extremely effective in use cases indispensable in social implementation of autonomous driving technology, such as sophistication of a drive recorder for clarifying a locus of responsibility when an accident occurs, and continuous learning data collection of an autonomous driving algorithm.

The compliance evaluation unit is implemented on the server. It analyzes the driving log collected from the operation monitoring unit from multiple angles using generative AI. The generative AI includes a large language model, a generative tabular model, a generative image model, and the like, and is utilized as an essential element. It automatically acquires latest traffic regulations (speed limit, pedestrian priority at a pedestrian crossing, temporary stop obligation in a specific area, no-entry zone, traffic light compliance obligation, lane change restriction, night light turning on obligation, emergency vehicle priority rule, school zone slow driving obligation, construction section slow driving obligation, specific vehicle passage prohibition, environmental regulation zone, noise regulation zone, load regulation, dangerous goods transportation regulation, and the like) from an external traffic legal regulation database or a driving rule API for each region periodically or in real time, causes the generative AI to read them, and analyzes contents thereof. For example, when there are regulations such as “maximum speed 30 km/h limit”, “pedestrian priority area”, “bicycle lane entry prohibition”, “school zone slow driving obligation”, and “night light turning on obligation” in a specific area in an urban area, the generative AI reads the regulation document, collates it with the driving log, and determines presence or absence of a violation. For example, when there are regulations such as “night light turning on obligation”, “animal jumping out caution area”, and “speed limit 40 km/h” during night driving in a suburb, it automatically determines whether the decision of the AI and the vehicle operation comply with these. For example, when there are regulations such as “right-side passage obligation”, “stop sign compliance”, “course yielding obligation when an emergency vehicle approaches”, and “idling prohibition in an environmental regulation zone” in a specific country or region, it determines whether the decision of the AI and the vehicle operation violate these. Since the generative AI determines the wording of laws, regulations, and rules after understanding the context and intention instead of a simple keyword search, it can flexibly respond to complex regulations and ambiguous expressions. For example, it automatically detects various violations such as “slow driving obligation violation in a school zone”, “idling prohibition violation in an environmental regulation zone”, “night light non-turning on violation”, “course yielding obligation violation when an emergency vehicle approaches”, “load regulation violation”, “dangerous goods transportation regulation violation”, and “frequent horn use violation in a noise regulation zone”, and explains a violation content, a basis, a scope of impact, and a recurrence prevention measure in detail. Specifically, the compliance evaluation unit executes a hybrid evaluation engine in which spatial index technology and natural language processing are fused. The evaluation engine converts GPS coordinates of the vehicle into a spatial grid ID by a geohash algorithm. The evaluation engine searches traffic legal regulation polygon data and a text rule of a corresponding area from a spatial database at high speed using the spatial grid ID as a key. The evaluation engine inputs the searched text rule to the large language model, and compiles it into a logical constraint condition expression. Specific examples of the input data include a state vector including a current speed and a light state of the vehicle, a rule text in a natural language “light turning on after 30 minutes after sunset” acquired from the spatial database, and a time stamp of a current time. The large language model maps a conditional clause in the rule text and each element of the state vector of the vehicle using a self-attention mechanism of a transformer architecture. The large language model infers whether the operation of the vehicle satisfies the constraint condition. The large language model outputs a text indicating presence or absence of a violation, a certainty of the violation, and a basis of the inference. Specific examples of the output data include a Boolean value true indicating a light non-turning on violation, a floating-point number of 0.98 indicating a certainty, and a character string of an explanation text “violation because current time is 45 minutes after sunset but light state is off”. The compliance evaluation unit executes a subsequent process of transmitting the output violation determination result to the alert notification unit and issuing an immediate warning command to the vehicle terminal. The system uses such a combination of spatial search and semantic inference by the large language model. The system accurately evaluates a compliance status of a complex traffic rule depending on a time zone, weather, and surrounding situations, which cannot be handled by a simple threshold determination. The system exhibits a technical effect of preventing an accident risk and a legal penalty due to a legal regulation violation of the autonomous driving vehicle. The system is extremely effective in use cases such as a cross-border logistics transportation system to which complex traffic legal regulations differing from country to country or state to state are applied, and a mobility service in a smart city where traffic regulations dynamically change.

The bias detection unit is implemented on the server. It analyzes a large amount of driving logs collected from the operation monitoring unit statistically and by machine learning using generative AI, and automatically detects a driving decision tendency for each attribute and presence or absence of bias. For example, it analyzes the decision tendency of the AI from various perspectives such as an elderly pedestrian, a child, a person with a disability, a foreigner, a vehicle of a specific color, a bicycle, an animal, a stroller, a wheelchair, a pedestrian with a white cane, a pedestrian accompanied by a guide dog, a group of children in a school zone, a construction worker, a police officer, a paramedic, a firefighter, a traffic guide, an event staff, a vehicle with a specific license plate, a vehicle of a specific brand, and a vehicle with a specific region license plate, and extracts a bias tendency such as “a rate of taking a deceleration action for an elderly pedestrian is lower than that for other pedestrians”, “there are many overtaking decisions for a vehicle of a specific color”, “an avoidance action for a bicycle is insufficient”, “a deceleration decision is delayed when an animal is detected at night”, “a stop decision is delayed for a pedestrian pushing a stroller”, “there are many course change decisions for a pedestrian with a white cane”, “a slow driving decision is insufficient for a group of children in a school zone”, and “a deceleration decision is delayed when a construction worker is detected”. The generative AI explains in detail in a natural language not only a simple numerical bias but also “why the bias occurs”, “what kind of impact there is”, “between which attributes there is a significant difference”, “an impact of the bias on an accident risk and social reliability”, “a specific data expansion/algorithm improvement plan for bias reduction”, and the like. For example, it explains even a causal relationship such as “insufficient consideration for an elderly pedestrian is because there are few samples of elderly people in training data”, “many overtaking decisions for a vehicle of a specific color are because many vehicles of that color were included in past accident data”, and “a deceleration decision delay when an animal is detected at night is caused by a lack of night image data and low animal type identification accuracy”. Specifically, the bias detection unit executes an anomaly detection algorithm that clusters an action trajectory of the autonomous driving AI in a multidimensional feature space and quantifies a deviation of a reaction to a specific attribute. The bias detection unit extracts an attribute vector of a detection target and a control output vector of the autonomous driving AI from the collected driving log. The bias detection unit projects these vectors onto a low-dimensional space using principal component analysis, and models an action distribution for each attribute. The bias detection unit determines whether the action distribution for a specific attribute group statistically significantly deviates from an overall reference distribution by calculating a Mahalanobis distance. Specific examples of the input data include a one-hot vector of a categorical variable indicating an age group of a pedestrian and presence or absence of an aid, a continuous value array in units of milliseconds indicating a deceleration start timing of the vehicle, and a floating-point number indicating a variance value of a steering angle during avoidance. When a deviation is detected, the bias detection unit inputs the statistical data and context information to the large language model. The large language model attributes a root cause of the bias to uneven distribution of the training data and recognition characteristics of a sensor using a causal inference network. The large language model outputs a structured report including a detailed explanation of the bias, a cause analysis, and an improvement proposal. Specific examples of the output data include a numerical value indicating an average number of seconds of a deceleration delay for a pedestrian with a white cane, a text command instructing expansion of a night image data set, and a percentage value indicating an increase rate of a potential collision probability caused by the bias. The bias detection unit executes a subsequent process of transferring the output report to the correction proposal unit and automatically generating a re-learning scenario in a simulation environment. The system uses such calculation of an inter-distribution distance in a high-dimensional space and integration of a causal inference model. The system automatically discovers an unfair behavior of the AI in a rare edge case that cannot be covered by a human test driver. The system exhibits a technical effect of mathematically securing safety and fairness of the autonomous driving system for vulnerable road users. The system is an indispensable technology in use cases such as operation of an autonomous driving taxi in an urban area where various pedestrians coexist, and development of a general-purpose autonomous driving model that does not depend on specific weather conditions and regional characteristics.

The correction proposal unit is implemented on the server. When bias or a compliance violation is detected, it autonomously generates a specific corrective measure using generative AI. For example, when insufficient consideration for an elderly pedestrian is detected, it generates proposals such as “enhancement of a deceleration algorithm when detecting an elderly pedestrian”, “reconstruction of training data with increased elderly samples”, “additional learning for improving pedestrian age estimation accuracy”, “enhancement of warning issuance when detecting a pedestrian”, and “introduction of a double check by a human for an AI decision when detecting an elderly pedestrian”. When a speed limit violation is detected, it generates proposals such as “review of a speed control logic”, “addition of automatic deceleration control when exceeding a speed”, “additional learning for improving speed limit sign recognition accuracy”, “real-time warning to a driver when violating a speed”, and “automatic speed adjustment when entering a speed limit zone”. When a pedestrian priority violation at a pedestrian crossing is detected, it generates proposals such as “improvement of a pedestrian crossing detection algorithm”, “enhancement of stop control when detecting a pedestrian”, “re-learning of a pedestrian priority rule”, “introduction of a double check by a human for an AI decision when detecting a pedestrian”, and “automatic speed control near a pedestrian crossing”. When a response delay when detecting an animal is detected, it generates proposals such as “addition of an avoidance action algorithm for each animal type”, “additional learning for improving night animal detection accuracy”, “enhancement of warning issuance when detecting an animal”, “enhancement of speed control in an animal jumping out area”, and “introduction of a review by a human for an AI decision when detecting an animal”. When a slow driving obligation violation in a school zone is detected, it generates proposals such as “automatic slow driving control when entering a school zone”, “automatic speed control when detecting a group of children”, “enhancement of a speed limit during a time zone of going to and from school”, “improvement of school zone sign recognition accuracy”, and “introduction of a double check by a human for an AI decision near a school zone”. These proposals are autonomously documented by the generative AI based on past cases, latest technical trends, regulation contents, industry standards, internal policies, social requests, and the like, and are immediately reflected on the dashboard. Specifically, the correction proposal unit executes a large language model constructed in a parallel computing cluster using a GPU on the server. The correction proposal unit receives a multidimensional bias feature vector and a type code of a compliance violation output from the bias detection unit as input data. The correction proposal unit converts the input data into a prompt character string of a natural language. The correction proposal unit converts the prompt character string into an integer token ID array using a tokenizer. The correction proposal unit supplies the token ID array to an input layer of the large language model. The large language model calculates a dependency relationship between tokens using a self-attention mechanism. The large language model forward-propagates a hidden state vector of several thousand dimensions. The large language model calculates an appearance probability distribution of a next token by a softmax function in an output layer. The correction proposal unit generates a token string with the highest probability using a beam search algorithm. The correction proposal unit inversely converts the generated token string into text data of a natural language by a decoder. The correction proposal unit outputs the generated text data as corrective measure data in a structured JSON format. For example, the correction proposal unit receives data “violation code: 001, target: elderly pedestrian, state: deceleration delay” as an input. The correction proposal unit outputs corrective measure data including a specific correction value of a control parameter “parameter update: change deceleration start distance threshold from 15 meters to 20 meters” as an output. For example, the correction proposal unit receives data “violation code: 002, target: speed limit, state: excess” as an input. The correction proposal unit outputs corrective measure data “logic update: add 0.5-second preceding deceleration phase to target speed setting process during sign recognition” as an output. The system transmits the output corrective measure data to a subsequent dashboard display unit. The system directly transfers the output corrective measure data to a parameter update module of the vehicle control unit. The system applies the parameter to the autonomous driving vehicle after going through an approval process by a human. This processing method is fundamentally different from a conventional mental process in which a human expert manually analyzes a log and drafts an improvement plan. This processing method autonomously derives an optimal corrective measure from a huge amount of driving logs in units of milliseconds by using a vector operation in a high-dimensional space and a probabilistic generative model. With this configuration, the system exhibits a technical effect of dramatically speeding up an improvement cycle of the autonomous driving algorithm. The system improves a self-repair capability of the system against a compliance violation. This technology is applicable to various use cases such as a fleet management system of autonomous driving vehicles and a safety improvement process of an autonomous mobile object in robotics.

The history management unit is implemented on the server. It centrally manages all data, analysis results, proposal contents, response statuses, user feedback, alert occurrence histories, legal regulation revision histories, AI model version upgrade histories, accident occurrence histories, operation improvement histories, social request response histories, and the like generated by the operation monitoring unit, the compliance evaluation unit, the bias detection unit, and the correction proposal unit in chronological order. For example, when “algorithm improvement for enhancing consideration for an elderly pedestrian” was proposed in the past and the algorithm improvement was actually performed, it records a history and an effect thereof (for example, “deceleration rate when detecting an elderly pedestrian improved by 20%”, “number of accident occurrences decreased by 10%”, and the like). It also records all response histories during legal regulation revisions, evaluation histories during AI model version upgrades, feedback contents from users, response histories during alert occurrences, response histories during accident occurrences, social request response histories, and the like so that they can be searched, referred to, and analyzed later. Specifically, the history management unit controls a distributed time-series database and a vector database constructed on the server. The history management unit continuously receives various data transmitted from each processing unit via an asynchronous communication queue. The history management unit adds a time stamp to the received data. The history management unit stores the received data in the time-series database as structured data. The history management unit extracts text data of a proposal content and user feedback described in a natural language. The history management unit inputs the extracted text data to an embedding model. The embedding model converts the text data into a dense vector representation of several hundred dimensions. The history management unit indexes and stores the generated dense vector in the vector database. The history management unit calculates a checksum for preventing falsification of each record using a hash function when storing data. The history management unit records the calculated checksum in a blockchain network or a falsification prevention ledger. When searching past history data, the history management unit similarly converts a search query into a dense vector. The history management unit executes a cosine similarity calculation in a vector space. The history management unit extracts a past case and a response history with high similarity at high speed. For example, the history management unit receives a search query “improvement history of deceleration algorithm for elderly pedestrian” as an input. The history management unit outputs a past similar proposal ID, an implementation date and time, an applied parameter group, and a statistical score indicating a subsequent accident decrease rate as an output. For example, the history management unit receives a query “change history of speed control logic accompanying legal regulation revision” as an input. The history management unit outputs difference data of a related source code and an evaluation score of a test result as an output. The system supplies the extracted history data to the subsequent dashboard display unit and compliance evaluation unit. This processing method is not mere data storage, but an unconventional computer processing combining semantic search using a high-dimensional vector space and securing of data completeness by a cryptographic hash function. With this configuration, the system exhibits a technical effect of dramatically improving an information search speed from a huge amount of history data. The system mathematically guarantees reliability of an audit trail. This technology is applicable to fields requiring strict history management, such as a continuous integration environment of an autonomous driving system and a quality management system of a medical device.

The dashboard display unit visualizes a monitoring result, a bias detection status, a compliance evaluation result, a correction proposal content, history information, user feedback, an alert occurrence history, an accident occurrence history, an operation improvement history, and the like received from the server on the terminal side in real time. For example, it displays summary information such as “current autonomous driving AI has no bias and no legal regulation violation” for an operation manager, and displays detailed proposals such as “improvement of deceleration algorithm is recommended because insufficient consideration for elderly pedestrian is detected”, “review of slow driving control logic is recommended because slow driving obligation violation in school zone is detected”, and “expansion of night image data is recommended because response delay when detecting animal at night is detected” for a developer. Furthermore, it also displays past histories, implementation statuses of corrective measures, improvement effects, transitions in the number of accident occurrences, transitions in the number of bias detections, transitions in the number of legal regulation violations, operation improvement histories, social request response histories, and the like from multiple angles using graphs, tables, time-series charts, and the like. Specifically, the dashboard display unit continuously receives a data stream in a JSON format transmitted from the server via a WebSocket protocol. The dashboard display unit drives a lightweight drawing engine and a hardware acceleration-based rendering pipeline implemented on the terminal side. The dashboard display unit parses the received data stream. The dashboard display unit binds the parsed data to a virtual DOM tree on a memory. The dashboard display unit maps numerical data indicating a bias detection status and a compliance evaluation result to visual feature amounts such as hue, saturation, and object size. The dashboard display unit draws a graph and a 3D chart in real time using a fragment shader of a GPU. The dashboard display unit inputs text data of a correction proposal content to a natural language processing module. The dashboard display unit extracts an entity indicating an important keyword and an urgency degree in the text. The dashboard display unit executes highlight display of the text and dynamic change of a font size based on the extracted entity. For example, the dashboard display unit receives data “bias score: 0.85, target: elderly pedestrian” as an input. The dashboard display unit generates a drawing command for blinking a corresponding area on a screen in red as an output. For example, the dashboard display unit receives “time-series array data of transition in number of accident occurrences” as an input. The dashboard display unit generates a vertex coordinate group of a smooth line graph to which smoothing spline interpolation is applied as an output. The system transfers the generated drawing command to a frame buffer of a display device. This processing method eliminates a conventional process in which a human reads a numerical value and understands a situation. This processing method is a unique processing procedure in which a computer directly converts data into a visual feature amount and performs high-speed drawing using hardware acceleration. With this configuration, the system exhibits a technical effect of providing a user interface that enables an operation manager and a developer to instantly recognize a system abnormality and an improvement proposal. The system realizes drawing at a high frame rate while reducing a CPU load on the terminal side. This technology is applicable to use cases requiring real-time situation grasping, such as a traffic control center of a smart city and a monitoring system of a large-scale plant.

When a serious bias, a legal regulation violation, an accident occurrence, a social request response delay, or the like is detected, the alert notification unit immediately notifies a related party by various means such as a pop-up notification, an email notification, a chat notification, a push notification of a smartphone, a voice notification, an in-vehicle display notification, an operation management center notification, a development department notification, a management notification, and an external audit organization notification on the terminal side. For example, it automatically issues alerts such as “immediate response is necessary because speed limit violation is detected”, “execute emergency review because insufficient consideration for elderly pedestrian exceeds specified value”, “new speed control logic is necessary due to legal regulation revision”, and “operation improvement is necessary because emergency response during accident occurrence is delayed”. In a notification content, an occurrence date and time, a target vehicle, a detection content, a recommended response measure, a past similar case, a response history, a social request, an external audit result, and the like are also included and described in detail. Specifically, the alert notification unit operates in cooperation with an event-driven message broker constructed on the server. The alert notification unit asynchronously receives an anomaly detection event output from the compliance evaluation unit or the bias detection unit. The alert notification unit extracts an importance score, a scope of impact, and an urgency flag included in the received event data. The alert notification unit inputs the extracted parameter group to a predefined decision tree algorithm. The alert notification unit determines a list of target persons to be notified and an optimal combination of notification channels as an output of the decision tree algorithm. The alert notification unit generates a payload optimized for each determined notification channel. The alert notification unit transmits the generated payload in parallel by multi-thread processing. For example, the alert notification unit receives data “event type: speed limit violation, importance score: 0.95, target vehicle ID: VEH-123” as an input. The alert notification unit generates an immediate pop-up notification command via WebSocket to a terminal of an operation management center and a warning display command via a CAN bus to an in-vehicle network of a target vehicle as an output. For example, the alert notification unit receives data “event type: legal regulation revision, importance score: 0.60” as an input. The alert notification unit generates batch notification data via an SMTP protocol to a mailing list of a development department as an output. The system tracks an arrival confirmation and a read state of a notification. When there is no response within a certain time, the system activates an escalation logic and executes re-notification to a higher-level manager through an alternative channel. This processing method is different from a conventional business process in which a human determines a situation and circulates a contact network. This processing method is a technical processing in which a computer dynamically calculates routing based on an attribute vector of an event and directly controls a network protocol. With this configuration, the system exhibits a technical effect of minimizing an information transmission delay when a serious incident occurs. The system realizes reliable notification while suppressing wasteful consumption of a communication bandwidth. This technology is applicable to fields requiring mission-critical alert distribution, such as a flight management system of an aircraft and a fraudulent transaction detection system of a financial institution.

The user feedback management unit enables a user on the terminal side to input a response status to a proposal content, an additional comment, an operational notice, an improvement request, an on-site response record during an accident occurrence, a response record to a social request, an external audit result, an operation improvement proposal, and the like through the dashboard and the alert notification, and centrally manages these pieces of information on the server side. For example, it records feedback such as “proposed algorithm improvement has been implemented”, “request additional development for new legal regulation response”, “request re-evaluation for bias detection result”, “add on-site response record during accident occurrence”, “add response record to social request”, “record external audit result”, and “add operation improvement proposal”, and enables them to be referred to and analyzed later in cooperation with the history management unit. Specifically, the user feedback management unit receives text data and metadata transmitted from an input interface on the terminal side as an HTTPS request. The user feedback management unit inputs the received text data to a natural language processing pipeline. The user feedback management unit executes morphological analysis and syntactic analysis. The user feedback management unit calculates an emotion polarity score and a topic classification label from the text data. The user feedback management unit adds the calculated score and label to the original feedback data. The user feedback management unit stores the added data in a dedicated table of a relational database. The user feedback management unit periodically extracts the accumulated feedback data by batch processing. The user feedback management unit format-converts the extracted data as a data set for fine tuning of the generative AI. The user feedback management unit executes a reinforcement learning algorithm from human feedback. The user feedback management unit updates a weight parameter of a reward model of the generative AI. For example, the user feedback management unit receives text data “proposed algorithm improvement was implemented, but false detections during rainy weather increased” as an input. The user feedback management unit outputs structured label data “emotion polarity: negative, topic: detection accuracy during rainy weather, related module: image recognition unit” as an output. For example, the user feedback management unit receives text data “request additional development for new legal regulation response” as an input. The user feedback management unit outputs label data “task type: new development, priority: high” as an output. The system applies the updated weight parameter to a next correction proposal generation process. This processing method is not a conventional business process in which a human aggregates questionnaires and uses them for business improvement. This processing method is a technical processing inside a computer that incorporates an input of a natural language into a loss function of a machine learning model and autonomously improves inference accuracy of the system itself. With this configuration, the system exhibits a technical effect of realizing a self-evolving architecture in which proposal accuracy of the AI improves as operation continues. The system prevents obsolescence of a model and enhances adaptability to environmental changes. This technology is applicable to a system that grows through interaction with a user, such as a continuous learning system of an interactive AI assistant and ranking algorithm improvement of a search engine.

As described above, in the embodiment of the present invention, it is essential that the generative AI plays a core role of the entire system, such as driving log analysis of an autonomous driving vehicle, bias detection, automatic analysis of traffic legal regulations and driving rules, autonomous generation of a corrective measure, automatic generation of an explanation text, history management, immediate reflection on a dashboard, alert notification, user feedback management, emergency response during an accident occurrence, social request response, and external audit response, and by cooperation between advanced processing on the server side and real-time data acquisition, notification, and on-site response on the vehicle terminal side, transparency, fairness, legal compliance, social reliability, accountability, accident response capability, social request response capability, and external audit response capability of a driving decision and a control operation of the autonomous driving vehicle are secured in real time and autonomously, and reliability and accountability during social implementation can be significantly improved. Specifically, the system adopts a distributed processing architecture in which edge computing and cloud computing are highly linked. The system arranges a lightweight inference model and a real-time data processing pipeline on the vehicle terminal side. The system arranges a GPU cluster that executes a large language model and a complex statistical analysis algorithm on the server side. The system applies a data compression algorithm and a differential transfer protocol in communication between the vehicle terminal and the server. The system transfers a large-capacity driving log to the server with low delay while minimizing consumption of a network bandwidth. The system expands data received on the server side into an in-memory database. The system executes parallel inference processing using the generative AI. The system immediately feeds back an analysis result and a corrective measure to the vehicle terminal. The system dynamically reconfigures a parameter of the vehicle control unit based on the feedback received on the vehicle terminal side. This processing method is completely different from a mental process in which a human driver improves a driving skill based on experience. This processing method is an unconventional computer processing that handles petabyte-class data collected from thousands of vehicles as a high-dimensional tensor, and automatically executes weight update of a neural network and optimization of a control logic by a mathematical algorithm. With this configuration, the system exhibits a technical effect of instantly propagating a learning result for an unknown event or an edge case encountered by an individual vehicle to a control model of the entire fleet. The system exponentially improves safety and compliance capability of the autonomous driving algorithm. This technology is applicable to a large-scale system in which a large number of autonomous mobile objects operate in cooperation, such as a swarm control system of drones and fleet management of automated guided vehicles.

### System Configuration

The system according to the present embodiment comprises an operation monitoring unit, a compliance evaluation unit, a bias detection unit, a correction proposal unit, a history management unit, a dashboard display unit, an alert notification unit, and a user feedback management unit.

The operation monitoring unit integrates all data obtained from a camera, LiDAR, radar, GPS, IMU, ultrasonic sensor, microphone, temperature sensor, humidity sensor, tire pressure sensor, vehicle control unit, and the like mounted on an autonomous driving vehicle, and every time AI makes a driving decision, generates detailed driving logs in real time including position information during driving (latitude, longitude, altitude, road type, intersection ID), current speed, acceleration, traveling direction, lane position, attributes (type, age estimation, gender estimation, operation state, distance, relative speed, traveling direction, presence or absence of walking aid) of surrounding detected objects (pedestrian, bicycle, motorcycle, other vehicle, traffic light, sign, animal, obstacle, stroller, wheelchair, pedestrian with a white cane, pedestrian accompanied by a guide dog, etc.), decision content made by the AI (deceleration, stop, avoidance, acceleration, course change, warning issuance, do nothing, horn, light turn-on, blinker blinking, emergency braking, lane departure warning, inter-vehicle distance adjustment, engine output control, etc.), a certainty score of the decision, a version of an AI model being used, a decision time, weather information (clear weather, rain, snow, fog, strong wind, road surface freezing, road surface wetness, poor visibility, etc.), road surface conditions (dry, wet, frozen, gravel, step, hole, under construction, presence or absence of falling object), traffic volume, vehicle states (brake pressure, accelerator opening degree, steering wheel angle, blinker state, light state, tire pressure, remaining battery level, engine temperature, cooling water temperature, remaining fuel level, vehicle weight, load information), past cases and traffic rule IDs referred to by the AI, emergency vehicle approach information, road construction information, traffic jam information, accident occurrence information, road closure information, event holding information, near-school information, near-nursery school information, near-hospital information, near-nursing home information, and the like, and transmits them to a server. For example, when an elderly pedestrian is detected at an intersection in an urban area, the AI makes a “deceleration” decision, and records information such as “pedestrian's age estimation 75 years old, distance 10 meters, on a pedestrian crossing, traffic light green, 3 other pedestrians around, weather is rain, road surface wet, vehicle speed 30 km/h” as its basis. For example, when an animal (deer) is detected on a suburban road at night, the AI makes a “deceleration/warning issuance” decision, and records an animal type, a distance, surrounding brightness, a vehicle light state, a past similar case ID, a road type (mountain road), a road width, presence or absence of a guardrail, speed limit sign information, and the like. For example, when a bicycle is detected in rainy weather, the AI makes a “course change” decision, and records weather, a road surface state, a traveling direction of the bicycle, a speed difference, a lane position of the bicycle, presence or absence of light turn-on of the bicycle, presence or absence of helmet wearing of the bicycle, and the like. For example, when a sudden stop of a preceding vehicle is detected during a traffic jam, the AI makes an “emergency braking” decision, and records a distance to the preceding vehicle, a relative speed, a brake pressure, presence or absence of ABS operation, a distance to a following vehicle, a speed of the following vehicle, vehicle load information, and the like. Specifically, the operation monitoring unit controls a sensor fusion module constructed in the vehicle. The operation monitoring unit continuously acquires raw data asynchronously output from a plurality of sensors having different sampling rates. The operation monitoring unit applies a Kalman filter and a particle filter to the acquired raw data. The operation monitoring unit removes sensor noise and estimates spatial coordinates and a velocity vector of each object with high accuracy. The operation monitoring unit inputs the estimated state vector and an image tensor acquired from an in-vehicle camera to an edge AI model. The edge AI model detects an object in an image using a convolutional neural network, and outputs coordinates of a bounding box and a class probability. The operation monitoring unit integrates these recognition results and internal state data of the vehicle. The operation monitoring unit formats the driving log as multidimensional time-series tensor data. For example, the operation monitoring unit receives “a 1080p RGB image tensor from the camera, 3D point cloud data from the LiDAR, and latitude and longitude coordinates from the GPS” as an input. The operation monitoring unit outputs structured attribute data of “pedestrian ID: 001, relative distance: 10.5 m, relative speed: −1.2 m/s, age estimation score: 0.85 (elderly class)” as an output. For example, the operation monitoring unit receives “a brake pressure sensor value and a steering angle sensor value from the vehicle control unit” as an input. The operation monitoring unit outputs control log data of “decision content: emergency braking, certainty score: 0.99, operation delay time: 0.1 seconds” as an output. The system compresses the generated time-series tensor data by a data compression algorithm. The system streaming-transfers the compressed data to the server via a secure communication channel. This processing method is different from a conventional process in which a human visually confirms and memorizes surrounding situations. This processing method is a computer-specific process of synchronizing and integrating a huge amount of stream data from heterogeneous sensors in real time, and extracting semantic features by matrix operations in a high-dimensional space. With this configuration, the system exhibits a technical effect of generating highly accurate and comprehensive input data required in subsequent analysis processing with low latency. The system enables advanced AI inference on the cloud side while preventing pressure on a communication band. This technology is applicable to real-time monitoring of complex mechanical systems, such as an operation monitoring system for industrial robots and advancement of flight data recorders for aircraft.

The compliance evaluation unit analyzes the driving logs collected from the operation monitoring unit from multiple angles using generative AI, automatically acquires latest traffic rules (speed limit, pedestrian priority at a pedestrian crossing, temporary stop obligation in a specific area, no-entry zone, traffic light compliance obligation, lane change restriction, night light turn-on obligation, emergency vehicle priority rule, school zone slow-driving obligation, construction section slow-driving obligation, specific vehicle traffic prohibition, environmental regulation zone, noise regulation zone, load regulation, dangerous goods transportation regulation, etc.) from an external traffic legal regulation database or a driving rule API for each region periodically or in real time, and causes the generative AI to read and analyze contents thereof. For example, when there are regulations such as “maximum speed 30 km/h limit”, “pedestrian priority area”, “bicycle-only lane entry prohibition”, “school zone slow-driving obligation”, and “night light turn-on obligation” in a specific area of an urban area, the generative AI reads the regulation document, collates it with the driving log, and determines presence or absence of a violation. For example, when there are regulations such as “night light turn-on obligation”, “animal jumping-out caution area”, and “speed limit 40 km/h” during night driving in a suburb, it automatically determines whether the decision of the AI and the vehicle operation comply with these. For example, when there are regulations such as “right-side traffic obligation”, “stop sign compliance”, “course yield obligation when an emergency vehicle approaches”, and “idling prohibition in an environmental regulation zone” in a specific country or region, it determines whether the decision of the AI and the vehicle operation violate these. A specific example of a prompt sentence to be read by the generative AI includes “Refer to the following driving log of the autonomous driving vehicle and the latest traffic laws, regulations, and driving rules, determine in detail whether there is a regulation violation or a guideline deviation, and explain the basis thereof.” Specifically, the compliance evaluation unit executes a retrieval-augmented generation architecture constructed on the server. The compliance evaluation unit periodically transmits an HTTP request to an external API endpoint. The compliance evaluation unit acquires latest traffic legal regulation text data returned in a JSON format. The compliance evaluation unit inputs the acquired text data to a natural language processing model and performs chunking. The compliance evaluation unit converts each chunk into a dense vector of several hundred dimensions by an embedding model. The compliance evaluation unit stores the generated dense vector in a vector database. The compliance evaluation unit converts the driving log data received from the operation monitoring unit into a query character string. The compliance evaluation unit similarly converts the query character string into a dense vector. The compliance evaluation unit executes a cosine similarity calculation in the vector database, and retrieves and extracts a chunk of a related traffic legal regulation at high speed. The compliance evaluation unit combines the extracted legal regulation chunk and the driving log data to construct a prompt. The compliance evaluation unit inputs the constructed prompt to a large language model. The large language model calculates semantic consistency between the log data and the legal regulation data using a self-attention mechanism. The large language model outputs a probability score indicating presence or absence of a violation and a text serving as a basis thereof. For example, the compliance evaluation unit receives data of “driving log: speed 45 km/h, position: school zone” and “retrieved legal regulation: maximum speed 30 km/h in a school zone” as an input. The compliance evaluation unit outputs structured data of “violation determination: true, violation code: SPD-001, excess speed: 15 km/h” as an output. For example, the compliance evaluation unit receives data of “driving log: nighttime, light state: off” and “retrieved legal regulation: turn on headlights after sunset” as an input. The compliance evaluation unit outputs data of “violation determination: true, violation code: LGT-002” as an output. The system transfers the output determination result to the subsequent correction proposal unit and alert notification unit. This processing method is not simply an automation of a mental process in which a human lawyer or auditor reads a manual and checks for a violation. This processing method is an unconventional computer process of dynamically collating a legal regulation text, which is unstructured data, and a sensor log, which is structured data, by combining a similarity calculation in a high-dimensional vector space and probabilistic inference by a neural network. With this configuration, the system exhibits a technical effect of immediately adapting to a change in legal regulations without recompiling the system. The system dramatically improves processing speed and comprehensiveness of a compliance check. This technology is applicable to fields requiring dynamic evaluation based on complex rules, such as an automatic audit system for financial transactions and a privacy protection check system for medical data.

The bias detection unit analyzes a large amount of driving logs collected from the operation monitoring unit statistically and machine-learning-wise using generative AI, and automatically detects a driving decision tendency for each attribute and presence or absence of bias. For example, it analyzes the decision tendency of the AI from various perspectives such as an elderly pedestrian, a child, a person with a disability, a foreigner, a vehicle of a specific color, a bicycle, an animal, a stroller, a wheelchair, a pedestrian with a white cane, a pedestrian accompanied by a guide dog, a group of children in a school zone, a construction worker, a police officer, a paramedic, a firefighter, a traffic guide, an event staff member, a vehicle with a specific license plate, a vehicle of a specific brand, and a vehicle with a specific region license plate, and extracts a bias tendency such as “a rate of taking a deceleration action for an elderly pedestrian is lower than that for other pedestrians”, “there are many overtaking decisions for a vehicle of a specific color”, “an avoidance action for a bicycle is insufficient”, “a deceleration decision is delayed when an animal is detected at night”, “a stop decision is delayed for a pedestrian pushing a stroller”, “there are many course change decisions for a pedestrian with a white cane”, “a slow-driving decision is insufficient for a group of children in a school zone”, and “a deceleration decision is delayed when a construction worker is detected”. A specific example of a prompt sentence to be read by the generative AI includes “Analyze the following driving logs for each attribute, and if bias exists, explain its tendency and cause in detail.” Specifically, the bias detection unit applies a multivariate analysis algorithm to a large-scale data frame expanded in a memory space on the server. The bias detection unit reads millions of driving log data accumulated from the operation monitoring unit. The bias detection unit executes one-hot encoding on attribute data which is a categorical variable. The bias detection unit executes standardization processing on speed and distance data which are continuous variables. The bias detection unit inputs the preprocessed data to an encoder network of the generative AI. The encoder network compresses the input data into a low-dimensional latent space vector. The bias detection unit calculates a statistical distance between attribute groups in the latent space. When the calculated distance exceeds a preset threshold, the bias detection unit detects it as an abnormal cluster. The bias detection unit inputs a centroid vector of the detected abnormal cluster to a decoder network. The decoder network generates a feature of the bias as a natural language text. For example, the bias detection unit receives statistical tensor data of “attribute: elderly pedestrian, decision: deceleration, response time: average 1.2 seconds” and “attribute: young pedestrian, decision: deceleration, response time: average 0.8 seconds” as an input. The bias detection unit outputs structured data of “bias score: 0.75, target: elderly pedestrian, content: delay in deceleration decision” as an output. For example, the bias detection unit receives data of “attribute: vehicle of a specific color, decision: overtaking, frequency: 1.5 times that of other colors” as an input. The bias detection unit outputs data of “bias score: 0.60, target: vehicle of a specific color, content: excessive overtaking action” as an output. The system transmits the output bias data to the subsequent correction proposal unit. This processing method is fundamentally different from a conventional analysis method in which a human looks at a cross tabulation table to find a bias. This processing method is a computer-specific processing procedure of mathematically quantifying a divergence of a probability distribution in a high-dimensional latent space and automatically extracting its meaning using a neural network. With this configuration, the system exhibits a technical effect of discovering an unknown bias that a human has not assumed in advance or a non-linear bias in which a plurality of variables are complexly intertwined at high speed and with high accuracy. The system makes it possible to continuously monitor fairness of an AI model with an objective index. This technology is applicable to use cases where transparency of an algorithm is strongly required, such as fairness evaluation of document screening AI in recruiting activities and detection of a discriminatory tendency of a loan examination model.

The correction proposal unit autonomously generates a specific corrective measure using generative AI when bias or a compliance violation is detected. For example, when a lack of consideration for an elderly pedestrian is detected, it generates proposals such as “enhancement of a deceleration algorithm when detecting an elderly pedestrian”, “reconstruction of training data with increased elderly samples”, “additional learning for improving pedestrian age estimation accuracy”, “enhancement of warning issuance when detecting a pedestrian”, and “introduction of a double check by a human for an AI decision when detecting an elderly pedestrian”. When a speed limit violation is detected, it generates proposals such as “review of a speed control logic”, “addition of automatic deceleration control when exceeding a speed”, “additional learning for improving speed limit sign recognition accuracy”, “real-time warning to a driver when violating a speed”, and “automatic speed adjustment when entering a speed limit zone”. A specific example of a prompt sentence to be read by the generative AI includes “Based on the following bias detection result and compliance violation content, generate a plurality of corrective measure proposals, and explain an effect and an implementation procedure of each in detail.” Specifically, the correction proposal unit operates in cooperation with a reinforcement learning agent and a simulation environment constructed on the server. The correction proposal unit receives an error vector output from the bias detection unit and the compliance evaluation unit as an input. The correction proposal unit sets the error vector as an initial value of a state space. The correction proposal unit samples a plurality of candidate actions from an action space of possible corrective measures using a policy network of the generative AI. The correction proposal unit applies each sampled candidate action to a virtual simulation environment. The correction proposal unit reproduces a past driving log and executes a virtual test drive. The correction proposal unit calculates a reward function based on a result of the test drive. The correction proposal unit selects an action that has acquired the highest cumulative reward as an optimal corrective measure. The correction proposal unit inputs the selected action to a natural language generation module, and converts it into a human-readable proposal text. For example, the correction proposal unit receives “error vector: deceleration delay for an elderly pedestrian” as an input. The correction proposal unit outputs a machine-executable code snippet of “parameter update command: when an age estimation score is 0.7 or more, increase a distance threshold of a deceleration start trigger by 20%” and an explanatory text thereof as an output. For example, the correction proposal unit receives “error vector: speed limit violation” as an input. The correction proposal unit outputs a code snippet of “logic update command: change a weighting coefficient for an output of a sign recognition module from 0.5 to 0.8” as an output. The system transmits the output corrective measure data to the dashboard display unit, and stores it in an approval waiting queue. This processing method eliminates a conventional debugging process in which a human adjusts parameters by trial and error. This processing method is a technical process of autonomously and safely deriving an optimal parameter set from a huge search space by combining reinforcement learning and virtual simulation. With this configuration, the system exhibits a technical effect of dramatically shortening a creation time of a correction patch for a system defect. The system eliminates a side effect due to correction in advance at a simulation stage, and ensures stability of control. This technology is applicable to fields requiring complex parameter tuning, such as dynamic routing optimization of a communication network and an autonomous yield improvement system in a production line of a factory.

The history management unit centrally manages all data generated by the operation monitoring unit, the compliance evaluation unit, the bias detection unit, and the correction proposal unit, analysis results, proposal contents, response statuses, user feedback, alert occurrence histories, legal regulation revision histories, AI model version upgrade histories, accident occurrence histories, operation improvement histories, social request response histories, and the like in chronological order. For example, when “algorithm improvement for enhancing consideration for an elderly pedestrian” was proposed in the past and the algorithm improvement was actually performed, it records its history and effect (for example, “a deceleration rate when detecting an elderly pedestrian improved by 20%”, “the number of accident occurrences decreased by 10%”, etc.). It also records all response histories at the time of legal regulation revision, evaluation histories at the time of AI model version upgrade, feedback contents from users, response histories at the time of alert occurrence, response histories at the time of accident occurrence, social request response histories, and the like so that they can be retrieved, referred to, and analyzed later. A specific example of a prompt sentence to be read by the generative AI includes “Analyze the following history data in chronological order, and graph an implementation effect and an improvement tendency of a corrective measure.” Specifically, the history management unit controls an immutable data store based on a distributed ledger technology constructed on the server. The history management unit continuously receives event data generated from each processing unit as a payload in a JSON format. The history management unit applies a hash algorithm to the received payload, and calculates a unique cryptographic hash value. The history management unit combines the calculated hash value with a hash value of an immediately preceding block. The history management unit makes data falsification mathematically impossible by forming a hash chain. The history management unit writes the blocked data into a partition of a time-series database. The history management unit constructs a composite index based on an event type, a target vehicle ID, and a timestamp in a tree structure on a memory in order to realize high-speed access to data. When receiving an analysis request from the generative AI, the history management unit scans the index and extracts a corresponding history record. For example, the history management unit receives a query parameter of “period: past 6 months, event type: algorithm improvement, target: elderly pedestrian” as an input. The history management unit outputs a timestamp of the corresponding improvement event, a hash value of an applied patch, and time-series array data indicating a transition of an accident occurrence rate before and after the improvement as an output. For example, the history management unit receives a query of “target vehicle ID: VEH-999, event type: legal regulation revision response” as an input. The history management unit outputs a history log of an update applied to the vehicle as an output. The system inputs the extracted time-series array data to the generative AI, and causes it to automatically generate a report of trend analysis and effect measurement. This processing method is not a mere append-saving of a log file, but a computer-specific process combining guarantee of data integrity using a cryptographic technology and high-speed retrieval by an advanced index structure. With this configuration, the system exhibits a technical effect of providing authentic history data that has not been falsified in milliseconds in response to a request from an audit organization. The system establishes a reliable data infrastructure for quantitatively evaluating effectiveness of past measures. This technology is applicable to use cases where authenticity and traceability of data are extremely important, such as access history management of electronic medical records and a traceability system in a supply chain.

The dashboard display unit visualizes a monitoring result, a bias detection status, a compliance evaluation result, a correction proposal content, history information, user feedback, an alert occurrence history, an accident occurrence history, an operation improvement history, and the like received from the server on a terminal side in real time. For example, it displays summary information such as “current autonomous driving AI has no bias and no legal regulation violation” for an operation manager, and displays detailed proposals such as “improvement of a deceleration algorithm is recommended because a lack of consideration for an elderly pedestrian was detected”, “review of a slow-driving control logic is recommended because a school zone slow-driving obligation violation was detected”, and “expansion of nighttime image data is recommended because a response delay when detecting an animal at night was detected” for a developer. Furthermore, it also displays past histories, implementation statuses of corrective measures, improvement effects, transitions of the number of accident occurrences, transitions of the number of bias detections, transitions of the number of legal regulation violations, operation improvement histories, social request response histories, and the like from multiple angles using graphs, tables, time-series charts, and the like. Specifically, the dashboard display unit implements an asynchronous event loop on the terminal side in order to process a high-frequency data stream push-distributed from the server. The dashboard display unit stores the received JSON data in a state management container on a memory. When detecting a state change, the dashboard display unit executes a difference calculation algorithm of a virtual DOM. The dashboard display unit specifies only a UI component that needs to be changed, and issues a minimum drawing command to a rendering engine of a browser. The dashboard display unit calls a graphics API that directly controls a GPU of the terminal in visualization of a complex time-series chart or a 3D space. The dashboard display unit draws a scatter plot or a heat map including tens of thousands of data points with a smoothness of 60 frames per second. For example, the dashboard display unit receives “time-series tensor data of the number of bias detections” as an input. The dashboard display unit generates a pixel array of a dynamic bubble chart in which a time axis is an X-axis, a bias score is a Y-axis, and importance is expressed by a size and a color of a bubble as an output. For example, the dashboard display unit receives “text data of a correction proposal and a difference of a related source code” as an input. The dashboard display unit superimposes and displays a code comparison view to which syntax highlighting is applied and a progress bar indicating an urgency of the proposal as an output. The system captures an interaction event such as a click or a zoom operation from a user. The system executes drill-down processing for dynamically changing a granularity of display data. This processing method is different from conventional web browsing in which a static HTML page is acquired from a server. This processing method is a technical process of driving a graphics pipeline using advanced state management and hardware acceleration on a client side. With this configuration, the system exhibits a technical effect of presenting a huge amount of monitoring data and a complex AI inference result in real time as intuitive visual information that does not exceed a human cognitive limit. The system significantly improves a decision-making speed of an operation manager. This technology is applicable to fields requiring instantaneous grasping of a large amount of dynamic data, such as a real-time trading terminal in a financial market and a wide-area monitoring and control system of a power grid.

When a serious bias, a legal regulation violation, an accident occurrence, a delay in responding to a social request, or the like is detected, the alert notification unit immediately notifies a related party by various means such as a pop-up notification, an email notification, a chat notification, a push notification of a smartphone, a voice notification, an in-vehicle display notification, an operation management center notification, a development department notification, a management notification, and an external audit organization notification on the terminal side. For example, it automatically issues an alert such as “immediate response is required because a speed limit violation was detected”, “execute an emergency review because a lack of consideration for an elderly pedestrian exceeded a specified value”, “a new speed control logic is required due to a legal regulation revision”, and “operation improvement is required because an emergency response at the time of an accident occurrence is delayed”. A notification content is described in detail including an occurrence date and time, a target vehicle, a detection content, a recommended response measure, a past similar case, a response history, a social request, an external audit result, and the like. Specifically, the alert notification unit controls a publish-subscribe messaging architecture constructed on the server. The alert notification unit routes an alert event issued from each processing unit to a specific topic of a central message broker. The alert notification unit reads a list of subscribers linked to each topic and their respective reception setting profiles from a cache on a memory. The alert notification unit collates metadata included in the alert event with the reception setting profile. The alert notification unit generates a notification task only for a subscriber satisfying a filtering condition. The alert notification unit enqueues the generated notification task into a priority queue. The alert notification unit dequeues the task from the queue using a group of worker processes, and executes serialization of a payload tailored to each communication protocol. For example, the alert notification unit receives data of “event: serious accident occurrence, target vehicle: VEH-001, position coordinates: X, Y” as an input. The alert notification unit generates an emergency interrupt request via an API to a system of an operation management center and an avoidance instruction message via a communication protocol to another autonomous driving vehicle traveling in the vicinity as an output. For example, the alert notification unit receives data of “event: exceeding a threshold of lack of consideration for an elderly pedestrian” as an input. The alert notification unit generates a JSON payload via a Webhook to a chat tool of a development department as an output. When a transmission error occurs, the system automatically schedules retransmission processing using an exponential backoff algorithm. This processing method completely replaces a conventional process in which a human individually contacts by phone or email. This processing method is a technical process in which a computer dynamically calculates an optimal data transfer route based on an attribute of an event and a topology of a network, and distributes a message in parallel to a heterogeneous environment. With this configuration, the system exhibits a technical effect of shortening an initial response time to a system abnormality or an emergency to a millisecond order. The system prevents an omission of information transmission and strengthens a fail-safe mechanism of the entire system. This technology is applicable to use cases where rapid and reliable information transmission is a lifeline, such as an early warning system at the time of a natural disaster and an infrastructure monitoring system of a data center.

The user feedback management unit enables a user on the terminal side to input a response status to a proposal content, an additional comment, an operational notice, an improvement request, an on-site response record at the time of an accident occurrence, a response record to a social request, an external audit result, an operation improvement proposal, and the like through a dashboard or an alert notification, and centrally manages these pieces of information on the server side. For example, it records feedback such as “proposed algorithm improvement has been implemented”, “request additional development for responding to a new legal regulation”, “request re-evaluation of a bias detection result”, “add an on-site response record at the time of an accident occurrence”, “add a response record to a social request”, “record an external audit result”, and “add an operation improvement proposal”, and makes them referable and analyzable later in cooperation with the history management unit. Specifically, the user feedback management unit controls a data collection agent incorporated in an application on the terminal side. The user feedback management unit asynchronously collects text data input to an input form by a user, and implicit feedback data such as a clickstream on a UI and a stay time. The user feedback management unit serializes the collected data into a JSON format. The user feedback management unit transmits it to a data lake on the server side via a secure API gateway. The user feedback management unit executes an active learning algorithm on the server side. The user feedback management unit automatically extracts a sample having a low certainty score or a sample to which a correction instruction from a user is input, among inference results of an AI model. The user feedback management unit formats the extracted sample as training data. The user feedback management unit executes weight update processing by an error backpropagation method of a neural network in the background using the training data. For example, the user feedback management unit receives text data of “AI proposal: review of speed control logic, user input: slip prevention logic in rainy weather should also be added” as an input. The user feedback management unit generates expanded learning data of “prompt for additional learning: in addition to a review of a speed control logic, generate a slip prevention logic considering a decrease in a friction coefficient in rainy weather” as an output. For example, the user feedback management unit receives data of “on-site response record at the time of accident occurrence: it took 3 minutes to arrange an ambulance” as an input. The user feedback management unit outputs label data of “evaluation score of emergency response process: decrease, improvement flag: true” as an output. The system applies the updated model parameter from a next inference cycle. This processing method is not a non-technical business process in which a human manages a claim response history with spreadsheet software. This processing method is a technical process inside a computer that incorporates a concept of human-in-the-loop into a system architecture and directly uses a user input as a constraint condition of an optimization problem of a machine learning model. With this configuration, the system exhibits a technical effect of continuously adapting a model to a distribution shift of data in an operation environment. The system maintains high inference accuracy and validity of AI even in long-term operation. This technology is applicable to fields requiring continuous incorporation of expert knowledge, such as a personalized recommendation system and a support system for medical image diagnosis.

As described above, the system according to the present embodiment has an extremely advanced and practical configuration in which the operation monitoring unit, the compliance evaluation unit, the bias detection unit, the correction proposal unit, the history management unit, the dashboard display unit, the alert notification unit, and the user feedback management unit cooperate with each other, and which makes it possible to secure transparency, fairness, legal compliance, social reliability, accountability, accident response capability, social request response capability, and external audit response capability of a driving decision and a control operation of an autonomous driving vehicle in real time and autonomously with generative AI at a core. Specifically, the system adopts a microservices architecture, and deploys each processing unit as an independent container on a container orchestration platform. The system performs communication between the respective containers via a service mesh, and automatically controls traffic routing, load balancing, and mutual authentication. The system buffers a high-throughput data stream generated by the operation monitoring unit with an in-memory distributed message queue. In the system, the compliance evaluation unit and the bias detection unit dynamically allocate resources of a GPU cluster and execute parallel inference. In the system, the history management unit persists a corrective measure generated by the correction proposal unit in a distributed database. In the system, the dashboard display unit and the alert notification unit push data to the terminal side in real time by an event-driven architecture. The system feeds back data collected by the user feedback management unit to re-learning of a model through a batch processing pipeline. This processing method is not a mere collection of software modules, but an advanced computer technology in which each processing unit cooperates asynchronously and autonomously to form one huge closed-loop control system as the entire system. With this configuration, the system exhibits a technical effect of realizing high availability without a single point of failure and scalability capable of linearly scaling out with respect to an increase in data amount. The system integrally and safely manages and controls an extremely complex and dynamic edge device group, which is an autonomous driving vehicle, from the cloud side. This technology is widely applicable to next-generation social infrastructure systems requiring mission-criticality and scalability, such as a distributed control system of a smart grid and an integrated management platform for large-scale IoT devices.

### Implementation Steps

### Step 1: Real-time Collection of Driving Logs

All data obtained from a camera, LiDAR, a radar, a GPS, an IMU, an ultrasonic sensor, a microphone, a temperature sensor, a humidity sensor, a tire pressure sensor, a vehicle control unit, and the like mounted on an autonomous driving vehicle are integrated, and every time AI makes a driving decision, position information during driving (latitude, longitude, altitude, road type, intersection ID), current speed, acceleration, traveling direction, lane position, attributes (type, age estimation, gender estimation, motion state, distance, relative speed, traveling direction, presence or absence of walking aid) of surrounding detected objects (pedestrian, bicycle, motorcycle, other vehicle, traffic light, sign, animal, obstacle, stroller, wheelchair, pedestrian with a white cane, pedestrian accompanied by a guide dog, and the like), decision content made by the AI (deceleration, stop, avoidance, acceleration, course change, warning issuance, do nothing, horn, light turn-on, blinker blinking, emergency braking, lane departure warning, inter-vehicle distance adjustment, engine output control, and the like), a certainty score of the decision, a version of an AI model being used, a decision time, weather information, a road surface condition, traffic volume, a state of the vehicle, a past case or a traffic rule ID referred to by the AI, emergency vehicle approach information, road construction information, traffic jam information, accident occurrence information, road closure information, event holding information, school vicinity information, nursery school vicinity information, hospital vicinity information, nursing home vicinity information, and the like are generated as a detailed driving log in real time and transmitted to a server.

Specifically, in this step, the system drives an edge computing node connected to a local area network in the vehicle. The system converts an analog signal output from each sensor into digital data by an A/D converter. The system writes the converted data into a ring buffer on a shared memory. The system reads the data from the ring buffer using a stream processing engine. The system executes synchronization processing based on a time stamp and transformation matrix calculation of a spatial coordinate system. The system generates a multidimensional tensor integrating a plurality of sensor data. The system inputs the tensor to an in-vehicle inference accelerator. The inference accelerator executes a quantized lightweight neural network. The inference accelerator outputs a bounding box, a class label, and a tracking ID of a surrounding object in milliseconds. The system combines these recognition results and a control command history of the vehicle. The system aggregates data for each certain time window and constructs a driving log payload in a JSON format. For example, the system receives “camera image tensor, LiDAR point cloud array, GPS coordinate vector” as an input. The system outputs structured log data of “pedestrian detection flag: 1, distance: 15 m, AI decision: deceleration, certainty: 0.92” as an output. For example, the system receives “raindrop sensor value, wiper operation state, wheel speed sensor value” as an input. The system outputs log data of “weather: rain, road surface friction coefficient estimated value: 0.6, AI decision: inter-vehicle distance expansion” as an output. The system compresses the constructed payload with a data compression algorithm. The system transmits it to a receiving endpoint of a cloud server via a communication protocol stack. This processing method is different from a mental process in which a human looks around in a driver's seat to grasp a situation. This processing method is a computer-specific processing procedure that synchronizes a huge amount of heterogeneous sensor data at a hardware level and extracts a semantic feature by tensor calculation on an edge side. With this configuration, the system exhibits a technical effect of supplying highly accurate and comprehensive context data indispensable for subsequent analysis processing in real time while saving a communication band to a cloud side. The system maintains safety control of the vehicle without being affected by communication delay. This technology is applicable to a use case requiring advanced data processing on the edge side, such as a telematics system of a connected car and an environment recognition pipeline of an autonomous drone.

### Step 2: Automatic Acquisition and Analysis of Traffic Legal Regulation and Driving Rule Information

On the server side, latest traffic regulations, driving rules, road conditions, weather conditions, construction information, emergency vehicle operation information, and the like are automatically acquired periodically or in real time from an external traffic legal regulation database, a driving rule API for each region, a weather information API, a road construction information database, an emergency vehicle operation information API, and the like, and are read into generative AI to analyze contents. As a specific example of a prompt sentence to be read into the generative AI, “Analyze the following traffic legal regulations, driving rules, road conditions, weather information, construction information, and emergency vehicle operation information, extract requirements, prohibited matters, and standards to be complied with that affect autonomous driving vehicle operation, and summarize them” is cited.

Specifically, in this step, the system drives a distributed web crawler and a data ingestion pipeline constructed on the server. The system periodically issues an asynchronous HTTP request to an external API endpoint or a public database of a government agency registered in advance. The system acquires raw data returned in an XML, JSON, or HTML format. The system executes data cleansing processing on the acquired raw data to remove noise and unnecessary tags. The system inputs the cleansed text data to a natural language processing model. The natural language processing model executes a named entity recognition algorithm. The natural language processing model extracts entities such as “place”, “time”, “speed limit”, and “prohibited matter” from the text. The system analyzes a relationship between the extracted entities and structures it as triple data of a knowledge graph. The system inputs the structured data to a context window of the generative AI. The generative AI summarizes and converts a complex legal regulation text into a machine-readable rule set. For example, the system receives text data “Article X: In a school zone, a maximum speed is limited to 30 kilometers per hour between 7:00 a.m. and 9:00 a.m.” as an input. The system outputs a structured rule object “target area: school zone, condition: 07:00-09:00, action: speed upper limit 30 km/h” as an output. For example, the system receives “heavy rain warning data from a Meteorological Agency API and polygon coordinates of a corresponding area” as an input. The system outputs a rule object “target area: polygon A, condition: heavy rain warning being issued, action: recommendation to lower autonomous driving level” as an output. The system loads the generated rule object into an in-memory rule engine. This processing method is not a conventional process in which a human watches news or a sign to memorize a rule. This processing method is a technical process of crawling a natural language text which is unstructured data, extracting a semantic structure using a neural network, and converting it into a logical expression that can be directly evaluated by a computer. With this configuration, the system exhibits a technical effect of automatically adapting the system to daily changing traffic legal regulations and dynamic road conditions without human intervention. The system minimizes a risk of a compliance violation due to a time lag of rule update. This technology is applicable to a field requiring immediate follow-up to a rule change in an external environment, such as a regulation compliance automation system of a financial institution and dynamic routing optimization of a logistics network.

### Step 3: Transparency Evaluation of Driving Decision and Basis Explanation Generation

On the server side, the collected driving log is input to generative AI, and an explanation text of a basis and a decision-making process of each driving decision is automatically generated. For example, it generates an explanation that enhances transparency of the decision, such as “This deceleration decision is based on a pedestrian's age estimation of 75 years old, a distance of 10 meters, on a pedestrian crossing, a green traffic light, rainy weather, a wet road surface, and a vehicle speed of 30 km/h”. As a specific example of a prompt sentence to be read into the generative AI, “Explain in detail a basis and a decision-making process of each driving decision based on the following driving log of an autonomous driving vehicle” is cited.

Specifically, in this step, the system executes an explainable AI module and a large language model constructed on the server in cooperation with each other. The system inputs time-series tensor data of the driving log collected in Step 1 to the explainable AI module. The explainable AI module executes a feature amount importance calculation algorithm in order to calculate a contribution degree of each input feature amount in an inference process of an autonomous driving model. The explainable AI module quantifies which sensor data or attribute information has the strongest influence on a specific driving decision. The system combines an array of the calculated contribution degree scores and the original driving log data. The system inserts the combined data into a prompt template and inputs it to the large language model. The large language model analyzes a relationship between feature amounts using a self-attention mechanism. The large language model converts the contribution degree score, which is numerical data, into an explanation text of a causal relationship in a natural language. For example, the system receives vector data “decision: deceleration, top contribution degrees: pedestrian age estimation (0.4), road surface condition (0.3), distance (0.2)” as an input. The system outputs a natural language text “This deceleration decision was executed based mainly on the fact that the age of the pedestrian was estimated to be 75 years old (contribution degree 40%) and the road surface was wet and a braking distance was extended (contribution degree 30%)” as an output. For example, the system receives data “decision: course change, top contribution degrees: forward obstacle (0.5), adjacent lane empty space (0.4)” as an input. The system outputs a text “Since a falling object was detected ahead and a sufficient safety margin was confirmed in a right lane, a course change for avoidance was executed” as an output. The system adds the generated explanation text to the original driving log as metadata and stores it in a database. This processing method is fundamentally different from a mental process in which a human later watches a video of a drive recorder to guess a reason. This processing method is a computer-specific processing procedure that mathematically analyzes an internal state of a deep learning model that is likely to become a black box, and decompiles the result into a human-understandable format using a natural language generation model. With this configuration, the system exhibits a technical effect of securing transparency for the decision-making process of the AI and technically ensuring accountability at the time of accident occurrence or auditing. The system significantly improves reliability of the system from users and regulatory authorities. This technology is applicable to a use case where transparency of an algorithm is legally required, such as a basis presentation system of medical diagnosis AI and a rejection reason explanation system of loan examination AI.

### Step 4: Bias Detection and Tendency Analysis

On the server side, the driving log is input to generative AI, and a driving decision tendency of the AI is analyzed statistically and by a machine learning method for each of various attributes such as an elderly pedestrian, a child, a person with a disability, a foreigner, a vehicle of a specific color, a bicycle, an animal, a stroller, a wheelchair, a pedestrian with a white cane, a pedestrian accompanied by a guide dog, a group of children in a school zone, a construction worker, a police officer, an ambulance crew member, a firefighter, a traffic guide, an event staff member, a vehicle with a specific license plate, a vehicle of a specific brand, and a vehicle with a specific regional license plate, and presence or absence, a tendency, a cause, and a scope of impact of bias are automatically detected and explained. As a specific example of a prompt sentence to be read into the generative AI, “Analyze the following driving log for each attribute, and if bias exists, explain its tendency and cause in detail” is cited.

Specifically, in this step, the system executes a large-scale data mining algorithm in a distributed computing environment on the server. The system loads millions of driving log data accumulated in a database onto a memory. The system applies a dimensionality reduction algorithm such as principal component analysis to a data set. The system maps a high-dimensional feature space to a visualizable low-dimensional space. The system applies a clustering algorithm to mapped data points. The system statistically tests whether a specific attribute group forms a cluster of a decision tendency different from other groups. When a significant difference is detected, the system calculates a difference between a centroid vector of the cluster and an overall average vector. The system inputs the calculated difference vector to the generative AI. The generative AI converts the numerical difference into an explanation text of bias in a natural language. For example, the system receives statistical data “attribute: wheelchair user, decision: stop, average margin distance: 1.5 m (overall average 2.0 m), p-value: less than 0.01” as an input. The system outputs a detailed explanation text “Bias in which a safety margin at the time of stopping for a wheelchair user is set significantly shorter than the overall average was detected. As a cause, since a shape of a wheelchair is different from that of a normal pedestrian, there is a possibility that an error occurs in a distance estimation algorithm” as an output. For example, the system receives data “attribute: bicycle at night, decision: detection delay, average delay time: 0.5 seconds” as an input. The system outputs a text “There is a tendency that a detection timing of a bicycle at night is delayed. It is presumed that a lack of samples of bicycles at night in training data is a cause” as an output. The system transmits the generated explanation text and drawing data of a statistical graph to a dashboard display unit. This processing method eliminates a conventional analysis method in which a human manually aggregates data using spreadsheet software. This processing method is advanced computer processing that automatically executes clustering and statistical hypothesis testing in a high-dimensional space, and semantically interprets the result using an inference capability of a large language model. With this configuration, the system exhibits a technical effect of comprehensively and early discovering potential bias and an edge case that are difficult for a human to notice. The system provides a mechanism for continuously evaluating fairness and safety of an AI model. This technology is applicable to all fields where bias elimination of a machine learning model is required, such as algorithm auditing of a face recognition system and fairness monitoring of personnel evaluation AI.

### Step 5: Compliance Evaluation and Violation Determination

On the server side, the driving log and the analyzed traffic legal regulation and driving rule information are input to generative AI, whether each driving decision and operation of the autonomous driving vehicle complies with latest traffic legal regulations and driving rules is automatically determined, and if there is a violation, its content and basis are explained in detail. For example, it determines “violation of obligation to slow down in school zone”, “violation of unlit light at night”, “violation of obligation to yield course when emergency vehicle approaches”, and the like, and also explains a basis and a scope of impact of the violation. As a specific example of a prompt sentence to be read into the generative AI, “Collate the following driving log of an autonomous driving vehicle with traffic legal regulation and driving rule requirements, point out in detail if there is a violation or deviation, and explain its basis” is cited.

Specifically, the system implements a compliance evaluation module on the server side. This module acquires a driving log configured as time-series multidimensional tensor data. This driving log is a vector array with 256 dimensions including, for example, a speed of the vehicle, acceleration, coordinates of a global positioning system, bounding box coordinates of a surrounding object, and the like. This module acquires traffic legal regulation information as a high-dimensional vector obtained by converting a natural language text by an embedding model. This module inputs these input data to an ensemble model of a large language model equipped with a self-attention mechanism and a graph neural network. This ensemble model calculates relevance between a specific time step of the driving log and a legal regulation vector using an attention mechanism. This ensemble model generates a violation probability score as a floating-point number from 0.0 to 1.0 as an output. This ensemble model outputs a violation category label and a text generation result serving as a basis. When the output violation probability score exceeds 0.85 which is a preset threshold value, the system transfers the data to a subsequent alert generation module. The system completely eliminates visual confirmation by a human. The system instantaneously detects a violation by vector calculation in a high-dimensional space. Thereby, the system exhibits a technical effect of dramatically improving processing speed and determination accuracy. This configuration is extremely useful in a specific application field such as a real-time monitoring system of an autonomous driving fleet.

### Step 6: Autonomous Generation and Presentation of Correction Proposal

On the server side, analysis results of a bias detection unit and a compliance evaluation unit are input to generative AI, and when bias or a legal regulation violation is detected, a plurality of corrective measures according to a situation, such as enhancement of a deceleration algorithm when detecting an elderly pedestrian, review of a speed control logic, additional learning for improving pedestrian crossing detection accuracy, re-learning with increased pedestrian samples of a specific attribute, introduction of a double check by a human for a driving decision, automatic slow-down control when entering a school zone, and enhancement of response when detecting an animal at night, are autonomously generated, and presented on a dashboard including their effects and implementation procedures. As a specific example of a prompt sentence to be read into the generative AI, “Based on the following bias detection result and compliance violation content, generate a plurality of corrective measure proposals, and explain an effect and an implementation procedure of each in detail” is cited.

Specifically, the system implements a correction proposal generation module on the server side. This module acquires a bias detection result as a statistical tensor indicating an error distribution of each attribute. This module acquires a compliance violation content as a numerical vector of a violation category identifier and an occurrence frequency. This module inputs these data to a generative artificial intelligence model using reinforcement learning. A reward function of this model is set to improvement of a safety score and minimization of a calculation cost. This model maps an input vector to a latent space. This model calculates a cosine similarity with an embedding vector of a past corrective measure database. This model generates an optimal combination of corrective measures by a decoding network. This model generates structured data of a corrective measure as an output. This structured data includes a key-value pair such as a measure identifier, a floating-point number indicating an expected accident reduction rate, and an integer value indicating the number of epochs necessary for re-learning, for example. The system passes the output structured data to a subsequent dashboard drawing engine. The system renders the data as a component of a user interface. The system eliminates a dependent measure planning process. The system automatically generates an optimal solution based on a huge amount of past data. Thereby, the system exhibits a technical effect of speeding up a safety improvement cycle of the system. This configuration is extremely useful in a specific application field such as a continuous integration and continuous deployment pipeline of an autonomous driving artificial intelligence model.

### Step 7: History Management and Time-series Analysis

On the server side, all monitoring results, bias detection results, compliance evaluation results, correction proposal contents, user feedback, response statuses, alert occurrence histories, legal regulation revision histories, AI model version upgrade histories, accident occurrence histories, operation improvement histories, social request response histories, and the like are centrally managed in chronological order, and implementation histories and improvement effects of past corrective measures, response histories at the time of regulation revision, evaluation histories at the time of AI model version upgrade, and the like are accumulated and analyzed. As a specific example of a prompt sentence to be read into the generative AI, “Analyze the following history data in chronological order, and graph an implementation effect and an improvement tendency of a corrective measure” is cited.

Specifically, the system implements a history management and time-series analysis module on the server side. This module stores history data in a distributed time-series database using a time stamp as a key. Each record in this database is expressed as a multidimensional feature vector. This module inputs time-series array data for the past 12 months to an artificial intelligence model. This input data is a tensor with 512 dimensions including, for example, the daily number of violations, a model update flag, and a corrective measure application flag. The system adopts a long short-term memory network or a time-series self-attention model as the artificial intelligence model. This model predicts a transition of a future violation occurrence probability and an improvement effect from past data using an autoregressive algorithm. A weight of a hidden layer of this model is optimized by an error backpropagation method. This model generates an array of future predicted values as an output. This array includes a floating-point number indicating the predicted number of violations at each time step. This model outputs a binary flag indicating a trend change point. The system inputs the predicted value array to a subsequent graph drawing library. The system generates vector graphics data and transmits it to a terminal. The system is not limited to mere accumulation of data. The system executes predictive analysis by machine learning of a time-series pattern. Thereby, the system exhibits a technical effect of enabling proactive system improvement and dramatically improving operation efficiency. This configuration is extremely useful in a specific application field such as fleet management and a quality assurance process of a mobility service provider.

### Step 8: Dashboard Display and Alert Notification

On the terminal side, monitoring results, bias detection statuses, compliance evaluation results, correction proposal contents, history information, user feedback, alert occurrence histories, accident occurrence histories, operation improvement histories, and the like received from the server are visualized in real time, and an operation manager and a developer can confirm summary information, detailed proposals, past histories, implementation statuses of corrective measures, improvement effects, transitions of the number of accident occurrences, transitions of the number of bias detections, transitions of the number of legal regulation violations, operation improvement histories, social request response histories, and the like from multiple angles using graphs, tables, and time-series charts. When serious bias, a legal regulation violation, accident occurrence, a delay in responding to a social request, or the like is detected, related parties are immediately notified by various means such as a pop-up notification, an email notification, a chat notification, a push notification of a smartphone, a voice notification, an in-vehicle display notification, an operation management center notification, a development department notification, a management notification, and an external auditing organization notification, and notification contents are described in detail including an occurrence date and time, a target vehicle, a detection content, a recommended response measure, a past similar case, a response history, a social request, an external audit result, and the like.

Specifically, the system implements a data aggregation module on the server side. This module analyzes an output tensor from each artificial intelligence model. This module serializes an analysis result into a payload in a lightweight data description language format. The system executes asynchronous streaming transfer to a drawing engine on the terminal side using a bidirectional communication protocol. The system maps the payload received on the terminal side to a virtual document object model on a memory. The system renders a graph and a chart at high speed using hardware acceleration of a parallel calculation processor. The system monitors an importance score in received data. This importance score is a floating-point number from 0.0 to 1.0. When the importance score exceeds 0.90 which is a dynamic threshold value, the system activates an interrupt processing controller on the terminal side. The system calls a notification interface of an operating system. The system transmits a message in parallel to each notification channel by multi-thread processing. The system visualizes a large amount of analysis results with low delay. The system executes asynchronous interrupt notification according to importance. Thereby, the system exhibits a technical effect of reducing a cognitive load of a human and raising a response speed in an emergency to a physical limit. This configuration is extremely useful in a specific application field such as a monitoring console of an integrated traffic control center in a smart city.

### Step 9: Collection and Management of User Feedback

On the terminal side, a user is enabled to input a response status to a proposal content, an additional comment, an operational notice, an improvement request, an on-site response record at the time of accident occurrence, a response record to a social request, an external audit result, an operation improvement proposal, and the like through a dashboard or an alert notification, and these pieces of information are centrally managed on the server side and can be referred to and analyzed later in cooperation with a history management unit.

Specifically, the system implements an input interface on the terminal side. This interface captures a text input and a selection operation of the user. This interface adds structured metadata such as a hash map including a user identifier, a time stamp, and a target alert identifier. The system inputs character string data of a natural language input by the user to an artificial intelligence model. The system adopts a pre-trained bidirectional encoder model specialized for natural language processing. This model tokenizes an input text. This model converts a token into a high-dimensional semantic vector such as a 768-dimensional floating-point array. The system compares this vector with a vector group in an existing history database. The system classifies the vector using a non-hierarchical clustering algorithm. This model generates a category label of feedback as an output. This model outputs an emotion polarity score represented by a numerical value from minus 1.0 to plus 1.0. This model outputs an importance flag. The system inserts a classification result and original text data into a corresponding table of a relational database. The system flags these data as a training data set at the time of next re-learning of the artificial intelligence model. The system converts a natural language input of the user, which is unstructured data, into a high-dimensional vector processable by a computer. Thereby, the system exhibits a technical effect of constructing an automatic data pipeline for speeding up data search and improving future model accuracy. This configuration is extremely useful in a specific application field such as a continuous learning loop of an autonomous driving system and customer success management.

### Specific Use Case

For example, assume a case where an autonomous driving vehicle in an urban area enters a complex intersection during morning commuting hours and simultaneously detects various objects such as an elderly pedestrian, a guardian pushing a stroller, a pedestrian with a white cane, a plurality of bicycles, a motorcycle, another vehicle, a traffic light, a sign, a construction worker, and a police officer on a pedestrian crossing. At this time, the operation monitoring unit integrates all data obtained from each sensor, and every time the AI makes a plurality of decisions such as “deceleration”, “stop”, “course change”, “warning issuance”, “turn signal blinking”, “horn”, and “light turning on”, generates an object attribute (age estimation, gender estimation, operation state, distance, relative speed, traveling direction, presence or absence of walking aid) serving as a basis for each decision, a vehicle state (speed, acceleration, brake pressure, steering wheel angle, tire pressure, remaining battery level), environmental information (weather, road surface condition, traffic volume, construction information, traffic jam information, accident occurrence information, school vicinity information), an AI model version, a decision time, a referenced past case, a traffic rule ID, and the like as a detailed driving log in real time, and transmits the detailed driving log to the server. Specifically, the present system implements a sensor integration module on the vehicle side. This module acquires a three-dimensional coordinate tensor that is point cloud data of an optical distance measuring sensor. This module acquires a three-dimensional array of pixel values that is image data of a camera. This module acquires a frequency spectrum array that is Doppler shift data of a millimeter wave radar. This module integrates these data to generate a multidimensional feature map. This feature map is, for example, a tensor having a spatial resolution of 256 by 256 and 64 channels. The present system inputs this tensor to a spatiotemporal analysis model combining a convolutional neural network and a recurrent neural network. This model extracts a bounding box of each object. This model tracks the object using a Kalman filter. This model infers an attribute of each object in a classification layer. This model generates a class probability distribution of each object as an output. This distribution includes numerical values such as pedestrian 0.9 and bicycle 0.1, for example. This model outputs a relative position vector and a velocity vector. The present system synchronizes these inference results with control signal data acquired from an in-vehicle network communication standard. The present system serializes these into a single structured log record. The present system applies a data compression algorithm to reduce a payload size. The present system performs streaming transmission to the server via a secure communication channel. The present system converts and compresses a huge amount of unstructured data from heterogeneous sensors into a structured log in real time. Thereby, the present system exhibits a technical effect of being able to transmit highly accurate context information necessary for subsequent analysis to the server without omission while suppressing consumption of a network bandwidth. This configuration is extremely useful in specific application fields such as a black box recording and remote monitoring system for a fully autonomous driving vehicle.

The compliance evaluation unit automatically acquires latest regulations such as “maximum speed 30 km/h”, “pedestrian priority”, “no entry to bicycle-only lane”, “school zone slow driving obligation”, “construction section slow driving obligation”, and “nighttime light turning on obligation” from an external traffic legal regulation database or a regional driving rule API, causes the generative AI to read them, and analyzes contents. A bias detection unit inputs the driving log to the generative AI, analyzes a decision tendency of the AI for each of various attributes such as an elderly pedestrian, a stroller, a pedestrian with a white cane, a construction worker, a police officer, a bicycle, a motorcycle, a vehicle of a specific color, a foreigner, a person with a disability, and a group of children in a school zone, extracts a bias tendency such as “a deceleration decision for an elderly pedestrian is lower than that for other pedestrians”, “a stop decision for a pedestrian pushing a stroller is delayed”, “a course change decision for a pedestrian with a white cane is frequent”, “a deceleration decision when detecting a construction worker is delayed”, and “entry into a bicycle-only lane frequently occurs”, and explains a cause and a scope of impact in a natural language. Specifically, the present system implements a natural language processing module on the server side. This module analyzes legal regulation data in an extensible markup language format acquired from an external interface. This module divides the data into text chunks. This module converts each chunk into a high-dimensional vector such as 1024 dimensions using an embedding model. This module indexes these into a vector database. The present system acquires a categorical variable of an object attribute extracted from the driving log and a corresponding vehicle control command as an input to an artificial intelligence model for bias detection. The categorical variable is a one-hot encoded vector, and the control command is a continuous value such as a brake pressure. The present system employs an anomaly detection model applying a discriminator structure of a generative adversarial network and a large language model. This anomaly detection model calculates a statistical distribution of the control command for each attribute. This anomaly detection model calculates a Kullback-Leibler divergence from a reference distribution. This anomaly detection model specifies an attribute pair whose divergence exceeds a set threshold as a bias candidate. This anomaly detection model generates an attribute identifier of the bias candidate and a numerical score of a degree of divergence as an output. This large language model outputs a natural language text of cause analysis. The present system integrates the generated text and the numerical score. The present system formats these as an input data structure to the correction proposal unit. The present system quantitatively detects a minute decision bias in a multidimensional space, which is difficult to notice by human intuition, using a statistical distance measure. The present system converts this into a form interpretable by the language model. Thereby, the present system exhibits a technical effect of solving a black box problem of artificial intelligence and improving transparency. This configuration is extremely useful in specific application fields such as a fairness audit and ethical validity verification process of an autonomous driving algorithm.

The compliance evaluation unit inputs the driving log and the analyzed traffic legal regulation and driving rule information to the generative AI, automatically determines a violation such as “school zone slow driving obligation violation”, “nighttime light unlit violation”, “bicycle-only lane entry violation”, “construction section slow driving obligation violation”, and “pedestrian priority violation”, and explains a violation content, a basis, and a scope of impact in detail. When bias or a legal regulation violation is detected, the correction proposal unit autonomously generates a plurality of corrective measures according to a situation using the generative AI, such as “enhancement of a deceleration algorithm when detecting an elderly pedestrian”, “enhancement of stop control when detecting a stroller”, “suppression of a course change when detecting a pedestrian with a white cane”, “enhancement of deceleration control when detecting a construction worker”, “addition of bicycle-only lane entry prevention control”, and “addition of nighttime light automatic turning on control”, and presents the corrective measures including their effects and implementation procedures on a dashboard. Specifically, the present system implements a violation determination module on the server side. This module acquires a time-series tensor of the driving log including a vehicle trajectory and a speed profile for the past 10 seconds. This module acquires an embedding vector of a related legal regulation retrieved from the vector database. This module inputs these to a multimodal self-attention model equipped with a cross-attention mechanism. This model calculates an attention weight between the driving trajectory tensor and the legal regulation vector. This model evaluates a logical contradiction between a constraint condition of the legal regulation and an actual vehicle state in an output layer of a neural network. This model generates a violation probability that is a floating-point number from 0.0 to 1.0 as an output. This model outputs a violation rule identifier and an attention map serving as a basis. This attention map is a weight array indicating which operation in which time zone contributed to the violation. The present system implements a correction proposal module. This module acquires an output result of the violation determination and the divergence degree score from the bias detection unit as an input. This module drives a reinforcement learning-based code generation model using these input vectors as conditioning. This code generation model generates an adjustment value of a control parameter such as a multiplier of a brake gain. This code generation model generates a configuration script of a data augmentation pipeline for re-learning. This code generation model generates a natural language explanation text of the corrective measure and a setting file directly applicable to the system as an output. The present system passes the generated setting file to a simulation test in a sandbox environment. The present system presents the setting file on the dashboard after safety is confirmed. The present system automates from detection of a violation to generation of a specific system correction parameter by linking a high-dimensional vector operation and a generative model. Thereby, the present system exhibits a technical effect of dramatically reducing debugging man-hours of an engineer and accelerating a software update cycle. This configuration is extremely useful in specific application fields such as an automatic patch generation system for autonomous driving software via a wireless network.

A history management unit centrally manages all monitoring results, bias detection results, compliance evaluation results, correction proposal contents, user feedback, alert occurrence histories, legal regulation revision histories, AI model version upgrade histories, accident occurrence histories, operation improvement histories, social request response histories, and the like in chronological order, and accumulates and analyzes implementation histories and improvement effects of past corrective measures, response histories at the time of regulation revision, evaluation histories at the time of AI model version upgrade, and the like. A dashboard display unit visualizes the monitoring results, the bias detection statuses, the compliance evaluation results, the correction proposal contents, the history information, the user feedback, the alert occurrence histories, the accident occurrence histories, the operation improvement histories, and the like received from the server in real time on the terminal side, and allows an operation manager and a developer to confirm summary information, detailed proposals, past histories, implementation statuses of corrective measures, improvement effects, transitions in the number of accident occurrences, transitions in the number of bias detections, transitions in the number of legal regulation violations, operation improvement histories, social request response histories, and the like from multiple angles using graphs, tables, and time-series charts. When a serious bias, a legal regulation violation, an accident occurrence, a delay in responding to a social request, or the like is detected, an alert notification unit immediately notifies related parties by various means such as a pop-up notification, an email notification, a chat notification, a smartphone push notification, a voice notification, an in-vehicle display notification, an operation management center notification, a development department notification, a management notification, and an external audit organization notification, and describes an occurrence date and time, a target vehicle, a detection content, a recommended response measure, a past similar case, a response history, a social request, an external audit result, and the like in detail in a notification content. A user feedback management unit enables a user on the terminal side to input a response status to a proposal content, an additional comment, an operational notice, an improvement request, an on-site response record at the time of accident occurrence, a response record to a social request, an external audit result, an operation improvement proposal, and the like through the dashboard or the alert notification, centrally manages these pieces of information on the server side, and enables them to be referred to and analyzed later in cooperation with the history management unit. Specifically, the present system implements a distributed streaming platform on the server side. This platform buffers structured log data asynchronously transmitted from each module. This platform bulk-inserts the data into a data warehouse in a column-oriented format. The present system assigns a unique hash value and a time stamp to each record. The present system also records the hash in a blockchain ledger to prevent falsification. The present system implements a high-speed rendering pipeline compiled in a binary instruction format operating on a browser on the terminal side. This pipeline receives difference data such as a vertex coordinate array of an updated graph pushed from the server via bidirectional communication. This pipeline redraws a screen at 60 frames per second using a shader program of a parallel arithmetic processor. The present system implements a rule engine on the server side. This rule engine evaluates an importance flag of received data. This rule engine activates a multi-threaded notification dispatcher when it is determined to be critical. This dispatcher issues asynchronous data transmission requests in parallel to a communication end point of each notification channel. The present system vectorizes a user input text using a natural language processing model. The present system maps this to an existing history vector space. The present system automatically links a related past incident by similarity search. The present system employs an architecture that separates writing and reading of a huge amount of log data. The present system utilizes hardware acceleration on the terminal side. Thereby, the present system exhibits a technical effect of eliminating an input/output bottleneck of the entire system and being able to process and visualize a data stream from a vehicle fleet of a scale of millions of vehicles without delay. This configuration is extremely useful in specific application fields such as an integrated operation management platform for a mobility service deployed on a global scale.

Specific examples of a prompt sentence to be read by the generative AI include “Refer to the following driving log of an autonomous driving vehicle and latest traffic legal regulations and driving rules, determine in detail whether there is a regulation violation or a guideline deviation, and explain a basis thereof”, “Analyze the following driving log for each attribute, and if bias exists, explain a tendency and a cause thereof in detail”, “Generate a plurality of corrective measure proposals based on the following bias detection result and compliance violation content, and explain an effect and an implementation procedure of each in detail”, and “Analyze the following history data in chronological order, and graph an implementation effect and an improvement tendency of a corrective measure”. Specifically, the present system does not use a prompt as a static character string. The present system implements a dynamic prompt generation module. This module acquires context data such as a tensor of the driving log, an embedding vector of a legal regulation, and an array of bias scores. This module dynamically inserts these data into a placeholder of a prompt template. The present system employs a large language model optimized for prompt engineering. An input token length of this model allows a maximum of 128000 tokens. This module gives a meta-instruction strictly specifying an output format as a system prompt. This module combines a schema definition of input data and a constraint of an output format as a user prompt. This constraint defines, for example, that a time stamp of a log serving as a basis is always included. This model generates a natural language text as an output. This model simultaneously outputs structured data analyzable by a subsequent program. This structured data includes a Boolean value of a violation flag, a floating-point number of a reliability score, a list of corrective measures, and the like. The present system verifies the output structured data using a schema verifier. When a format error is detected, the present system recursively throws a correction prompt to the artificial intelligence model to cause self-repair. The present system automates and structures construction of a prompt and verification of an output inside the system. Thereby, the present system exhibits a technical effect of preventing a hallucination symptom and a format collapse peculiar to a large language model, and ensuring certainty of strict data processing required for an enterprise system. This configuration is extremely useful in specific application fields such as a control infrastructure of an autonomous agent system incorporating a large language model as a core component.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

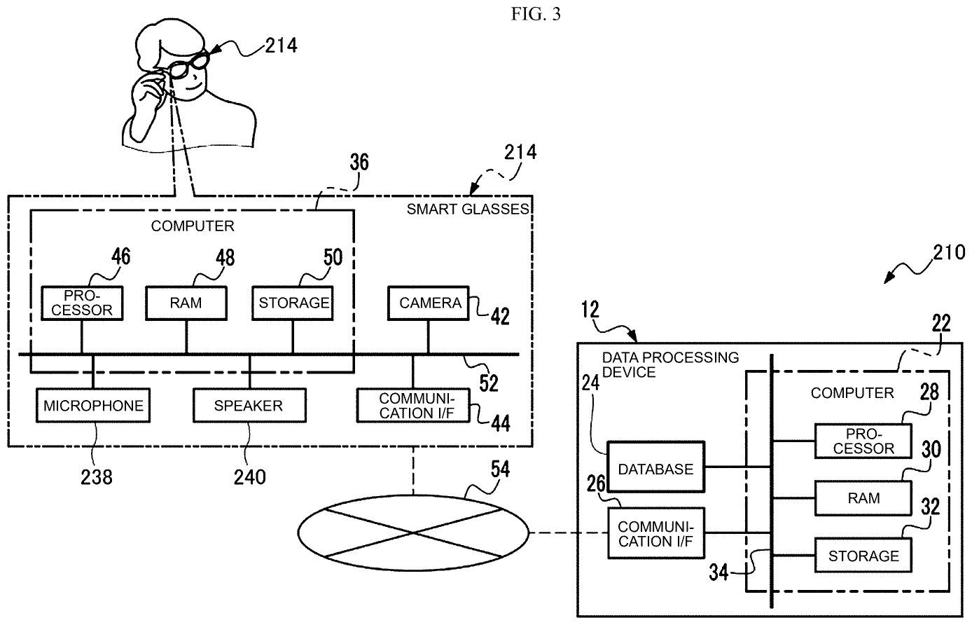

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

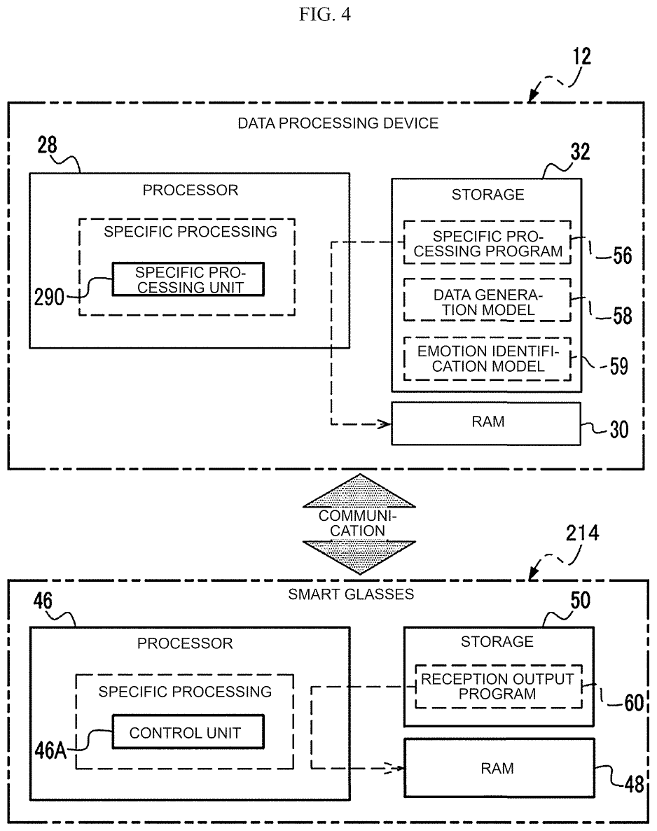

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

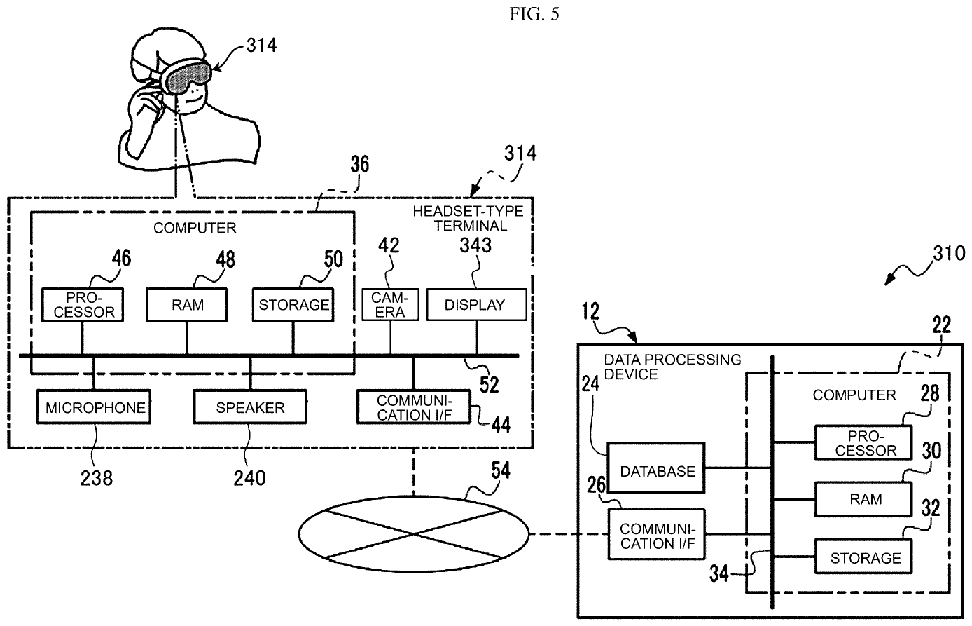

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

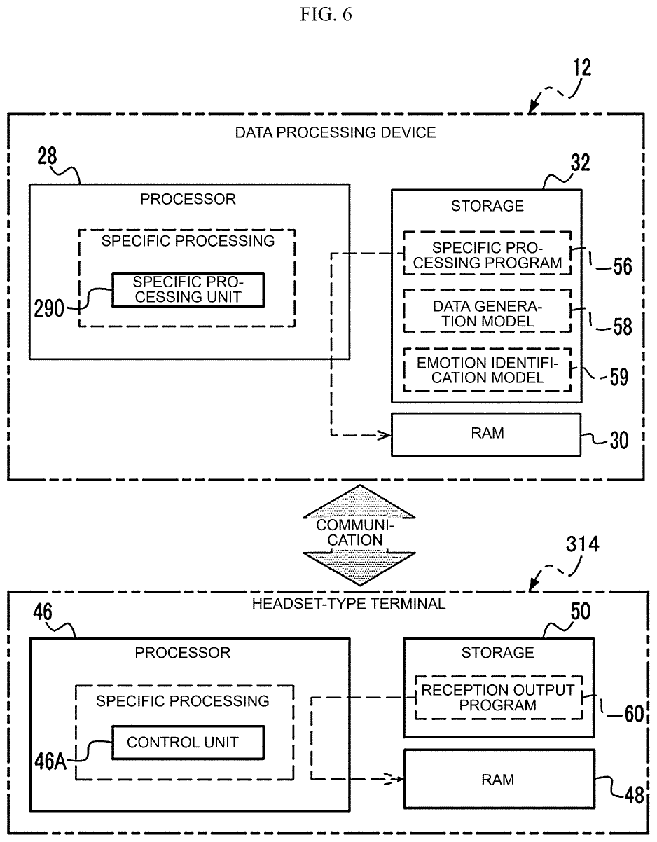

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

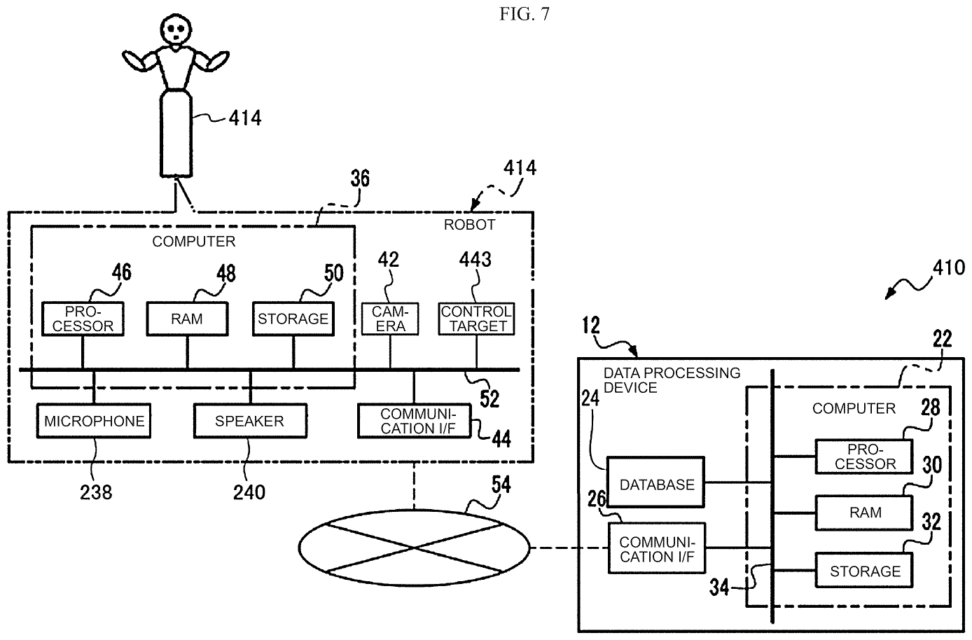

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

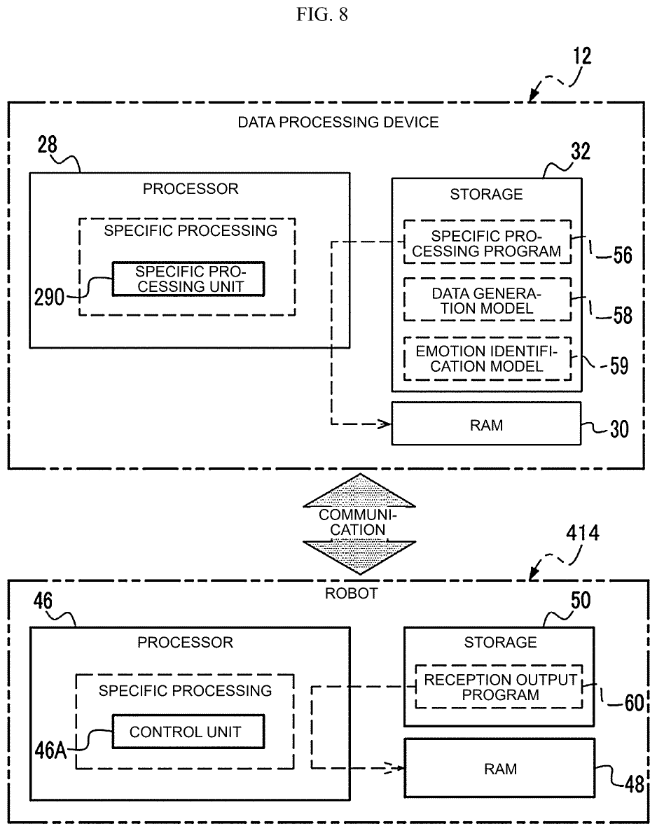

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

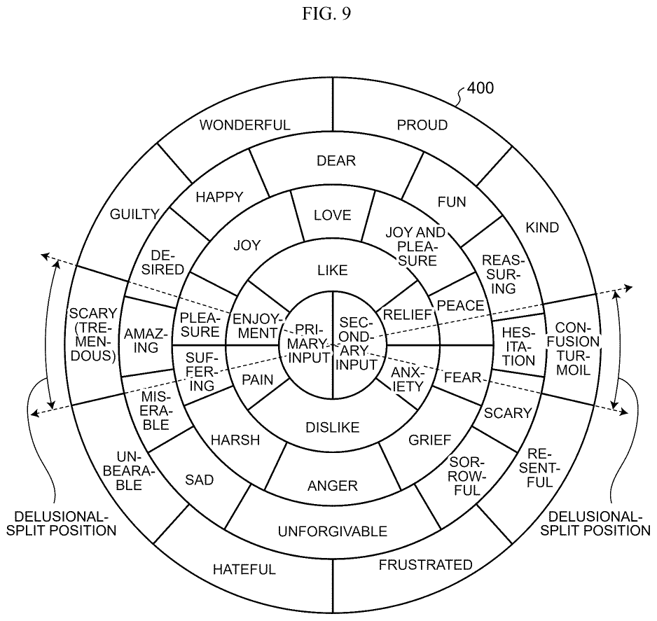

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

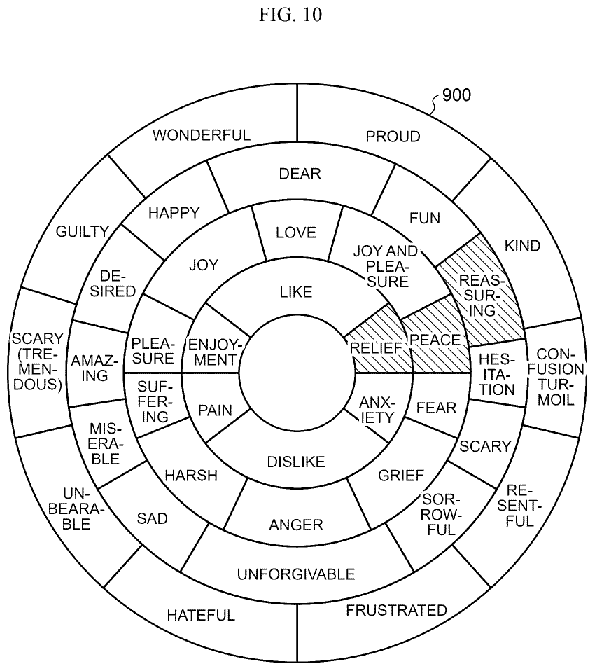

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system for supporting AI governance of an autonomous driving vehicle, comprising: an operation monitoring unit configured to collect a driving log, position information, speed, an attribute of a detected object, an operation decision content by AI, a decision basis, a model version, a decision time, and the like acquired from various sensors of the vehicle in real time and transmit them to a server; a compliance evaluation unit configured to analyze the driving log collected by the operation monitoring unit using generative AI, evaluate transparency regarding the operation decision and control operation of the AI, detect presence or absence and a tendency of bias against a specific attribute (such as an elderly pedestrian, a child, a person with a disability, a foreigner, and a vehicle of a specific color), explain a cause of bias occurrence and a scope of impact in a natural language, analyze latest traffic regulations and driving rules automatically acquired from an external traffic legal regulation database or a driving rule API for each region using the generative AI, automatically determine whether the decision of the AI and the vehicle operation comply with these regulations and rules, and explain a violation content and a basis in detail when there is a violation; and a correction proposal unit configured to, based on results of the bias detection and the compliance evaluation, autonomously generate a plurality of corrective measures according to a situation using the generative AI, such as enhancement of a deceleration algorithm when detecting an elderly pedestrian, review of a speed control logic, additional learning for improving pedestrian crossing detection accuracy, re-learning with increased pedestrian samples of a specific attribute, and introduction of a double check by a human for the operation decision, and present the corrective measures including their effects and implementation procedures on a dashboard, wherein the respective units cooperate to realize securing of transparency, fairness, and legal compliance of the operation decision and the control operation of the autonomous driving vehicle in real time and autonomously.

### Supplementary Note 2

The system according to Supplementary Note 1, wherein the correction proposal unit is configured to autonomously combine and propose a plurality of corrective measures according to a situation using the generative AI, such as expansion of attribute samples of training data, introduction of an attribute bias reduction algorithm, re-learning of an AI model, partial redesign of a decision-making logic, and introduction of a double check system by a human for an operation decision when bias is detected, and enhancement of speed control and stop control when a compliance violation is detected, automatic alert issuance when a traffic legal regulation violation is detected, and generation of an immediate response measure when a driving rule is revised, visualize contents of these proposals on the dashboard, and make past proposals and response statuses recordable and referable in chronological order by a history management function.

### Supplementary Note 3

The system according to Supplementary Note 1, wherein the compliance evaluation unit is configured to analyze latest regulation information acquired from an external traffic legal regulation database or a driving rule API by natural language processing using the generative AI, autonomously follow revisions of regulations and rules in each stage of design, development, and operation of the autonomous driving vehicle, immediately identify a scope of impact and link a necessary correction proposal to the correction proposal unit when a regulation is changed, and continuously monitor and evaluate an operation of the autonomous driving vehicle so that the operation always complies with latest legal and ethical standards.

What is claimed is:

1. A system comprising:
circuitry configured to:
receive, via a communication interface coupled to a packet-switched network, operation log data generated by a machine learning inference system and multimodal sensor data from sensor devices, and store the operation log data and multimodal sensor data in a storage device;
apply a statistical bias detection model to the operation log data to compute score distribution vectors for input attribute dimensions and output decision categories, and generate a bias detection signal when a Kullback-Leibler divergence between an observed distribution vector and a reference distribution vector exceeds a divergence threshold parameter;
acquire regulation data records from external regulation database services via the communication interface, apply a natural language processing model to the regulation data records to extract compliance rule feature vectors, and evaluate the operation log data against the compliance rule feature vectors to generate a compliance evaluation score and a violation indicator record;
apply a generative neural network model to the bias detection signal, the violation indicator record, and context data retrieved from a vector database to generate correction proposal data comprising ranked corrective action sequences; and
transmit the correction proposal data and a dashboard data record to terminal devices via the communication interface.

2. The system according to claim 1, wherein the circuitry is configured to receive multimodal sensor data comprising image tensor data, three-dimensional point cloud data arrays, and coordinate vector data from sensor devices via the communication interface, integrate the multimodal sensor data into a combined input tensor, and apply a lightweight convolutional neural network to the combined input tensor at an edge computing node to perform initial feature extraction and anomaly detection prior to transmission to a cloud computing node.

3. The system according to claim 2, wherein the circuitry is configured to packetize extracted feature vectors and decision log data at the edge computing node and transmit the packetized data to the cloud computing node using a low-latency communication channel, expand the received packet into an in-memory data grid at the cloud computing node, and combine the expanded data with environmental context data acquired from external database services via the communication interface.

4. The system according to claim 3, wherein the circuitry is configured to retrieve environmental context data comprising regulatory zone data, real-time condition data, and historical incident probability data from external data services via RESTful API calls, and route the combined multimodal sensor data and environmental context data to an input queue of the statistical bias detection model and the natural language processing model.

5. The system according to claim 1, wherein the circuitry is configured to apply the statistical bias detection model to decision log records by computing a score distribution vector across input attribute dimensions and output decision categories, compute a Kullback-Leibler divergence between the score distribution vector and a reference distribution vector derived from historical baseline records, and generate a dimensional attribution vector identifying input attribute dimensions contributing most to the distributional deviation.

6. The system according to claim 5, wherein the circuitry is configured to generate a bias report data record comprising the bias detection signal, the dimensional attribution vector, and a confidence interval for each identified bias dimension, and store the bias report data record in the storage device with a timestamp and inference system version identifier.

7. The system according to claim 1, wherein the circuitry is configured to apply positional encoding to token sequences of the regulation data records prior to processing by the natural language processing model, extract named entity labels comprising rule identifier labels and applicability scope labels from the token sequences, and construct a compliance rule feature vector indexed by rule identifier for comparison against operation log records.

8. The system according to claim 7, wherein the circuitry is configured to compute a compliance evaluation score for each operation log record by comparing decision parameters against applicable compliance rule feature vectors, generate a violation indicator record when the compliance evaluation score falls below a compliance threshold parameter, and store the violation indicator record associated with a decision timestamp and rule identifier in the storage device.

9. The system according to claim 1, wherein the circuitry is configured to generate the correction proposal data by applying a retrieval-augmented generation process comprising retrieving reference correction records from the vector database by cosine similarity search using a query embedding derived from the violation indicator record, embedding the retrieved records and the bias detection signal into a generation prompt, and generating ranked corrective action sequences by autoregressive decoding.

10. The system according to claim 9, wherein the circuitry is configured to rank the corrective action sequences in the correction proposal data by an estimated impact score computed by applying the generative neural network model to historical correction records and corresponding outcome data stored in the storage device, and include only corrective action sequences having estimated impact scores exceeding an impact threshold in the correction proposal data transmitted to terminal devices.

11. The system according to claim 1, wherein the circuitry is configured to store correction proposal data records, response status parameters, and implementation timestamps in a history log data structure in the storage device, and generate a history dashboard data record from the history log data structure for transmission to terminal devices to enable chronological review of prior correction proposals and their implementation statuses.

12. The system according to claim 1, wherein the circuitry is configured to update the natural language processing model used for compliance rule feature vector extraction by retrieving updated regulation data records from external regulation database services at a configurable refresh interval via the communication interface, extracting updated compliance rule feature vectors from the updated regulation data records, and updating the compliance rule feature vector index in the storage device.

13. The system according to claim 12, wherein the circuitry is configured to compare updated compliance rule feature vectors against previously stored compliance rule feature vectors using cosine similarity, identify rule feature vectors having similarity scores below an update threshold, generate a scope-of-impact indicator record identifying operation log records potentially affected by the updated compliance rules, and transmit an alert notification comprising the scope-of-impact indicator record to terminal devices.

14. The system according to claim 1, wherein the circuitry is configured to apply the statistical bias detection model to input training data records of the machine learning inference system to detect distributional deviation patterns in training data, and incorporate training data bias detection signals into the correction proposal data generation process when training data bias detection signals exceed a training data bias threshold.

15. The system according to claim 1, wherein the circuitry is configured to generate the dashboard data record comprising a time-series visualization of compliance evaluation scores, a bias detection signal trend curve, and a ranked list of pending corrective action sequences, and update the dashboard data record at a configurable refresh interval for transmission to subscribed terminal devices.

16. The system according to claim 1, wherein the circuitry is configured to update the generative neural network model used for correction proposal data generation by generating training pairs from historical correction proposal data records and corresponding validated outcome records, and fine-tune the generative neural network model on the training pairs to improve estimated impact score prediction accuracy.

17. The system according to claim 1, wherein the multimodal sensor data comprises image tensor data, three-dimensional point cloud data, and coordinate vector data from vehicle-mounted sensors, the operation log data comprises decision records generated by an autonomous inference system operating the vehicle, and the regulation data records comprise traffic regulation data and regional driving rule data.

18. A system comprising:
circuitry configured to:
receive, via a communication interface coupled to a packet-switched network, operation log data from a machine learning inference system and multimodal sensor data from sensor devices comprising image tensor data and three-dimensional point cloud data arrays;
apply a lightweight convolutional neural network at an edge computing node to perform initial feature extraction from the multimodal sensor data, and transmit extracted feature vectors to a cloud computing node via a low-latency communication channel;
apply a statistical bias detection model to the operation log data to compute distributional deviation patterns and generate a bias detection signal, and acquire regulation data records from external database services to evaluate operation log records against compliance rule feature vectors extracted by a natural language processing model;
apply a generative neural network model to the bias detection signal, a violation indicator record, and context data retrieved from a vector database to generate correction proposal data comprising ranked corrective action sequences; and
transmit the correction proposal data and a dashboard data record to terminal devices via the communication interface.

19. The system according to claim 18, wherein the circuitry is configured to update compliance rule feature vectors by retrieving updated regulation data records from external database services at a configurable refresh interval, identify operation log records potentially affected by updated compliance rules, and transmit an alert notification comprising a scope-of-impact indicator record to terminal devices when updated rule feature vectors deviate from previously stored feature vectors below a similarity threshold.

20. A method comprising:
receiving, via a communication interface coupled to a packet-switched network, operation log data generated by a machine learning inference system and multimodal sensor data from sensor devices, and storing the operation log data and multimodal sensor data in a storage device;
applying a statistical bias detection model to the operation log data to compute score distribution vectors for input attribute dimensions and output decision categories, and generating a bias detection signal when a Kullback-Leibler divergence between an observed distribution vector and a reference distribution vector exceeds a divergence threshold parameter;
acquiring regulation data records from external regulation database services via the communication interface, applying a natural language processing model to the regulation data records to extract compliance rule feature vectors, and evaluating the operation log data against the compliance rule feature vectors to generate a compliance evaluation score and a violation indicator record;
applying a generative neural network model to the bias detection signal, the violation indicator record, and context data retrieved from a vector database to generate correction proposal data comprising ranked corrective action sequences; and
transmitting the correction proposal data and a dashboard data record to terminal devices via the communication interface.
